(19) United States
(12) Patent Application Publication
(10) Pub. No.: US 2012/0222938 A1
(43) Pub. Date: Sep. 6, 2012

(54) LARGE BOTTLE VENDING APPARATUS AND METHOD

(76) Inventors: R. Edward Rose, JR., Hingham, MA (US); R. Edward Rose, III, Hingham, MA (US); Michael James Verrochi, Norwell, MA (US)

(21) Appl. No.: 13/407,452

(22) Filed: Feb. 28, 2012

Related U.S. Application Data
(60) Provisional application No. 61/448,493, filed on Mar. 2, 2011.

(51) Int. Cl. B65G 43/08; B65G 37/00

(52) U.S. Cl. 198/572; 198/602

(57) ABSTRACT

A combination vending/return apparatus and method. The apparatus includes a combination of rows and columns for receiving, storing and dispensing unfilled and filled large-volume fluid-containing bottles from and to consumers. The apparatus includes a processor-controlled vending keyboard/screen for making bottle selections for purchase and returns, and to handle electronic payment and credit transactions. Also disclosed is a method to vend large-volume fluid-containing bottles and retrieve used and emptied large-volume water bottles.

### CROSS-REFERENCE TO RELATED APPLICATION

This application claims priority to U.S. Provisional Application Ser. No. 61/448,493 filed Mar. 2, 2011, the contents of which are incorporated in their entirety herein by reference.

### FIELD OF THE DISCLOSURE

The disclosure relates generally to a vending apparatus for vending consumable goods and for receiving emptied reusable containers for the consumable goods. More specifically, the disclosure relates to an apparatus for vending large volume water bottles and receiving emptied re-sanitizable and reusable bottles.

### BACKGROUND OF THE DISCLOSURE

Potable, portable water has become an increasingly sought-after and common-place commodity by modern day consumers. Whether natural spring water or purified and/or re-mineralized drinking water, to address varying consumer demands for convenience and availability, water vendors have developed a number of bottle sizes and approaches for dispensing and delivering water. One such approach described more fully below uses established food stores, e.g., supermarkets and wholesale establishments, within which bottled water in varying sizes is offered on store shelves. A second approach is to offer larger 3 and 5 gallon bottles, often stacked independently of the market's shelves due to their considerable weight, to be used with water coolers for dispensing.

For companies involved in the home and office water delivery business, competition with respect to price, service, contract terms, availability of product, consistency of product, permitting in and out of state, delivery expenses including the acquisition of, or lease of, government approved trucks, fuel costs, tolls, taxes, maintenance and repair, labor and labor related benefits all add considerably to the cost of the delivered water. Additional costs such as a sales force, bookkeeping department, plant inventory, delivered inventory, truck-loaded inventory and FIFO handling of product inventory, further add to the cost. Regional weather and security-related issues can affect deliveries to homes, offices and apartment buildings.

An additional problem is the use of rented water coolers. Companies providing on-site delivery services that rent coolers to their customers have to deal with repair and maintenance, cleaning, billing and collection of rental fees and access to gated communities and high-rise apartments.

A yet further set of issues with respect to the home/office delivery business concerns state permitting practices and procedures. States vary considerably in their permitting requirements such that one company may decide against doing business in certain states to avoid disparate permitting requirements.

Distribution of particular brands of water for home/office delivery may be further restricted by geographical considerations, such as distance from a bottling facility. Many homes and businesses may be outside the feasible mileage radius of the bottling plant to warrant delivery at a competitive or acceptable price. The end result is the delivery of bottles and coolers along with all the related costs creates a fractionalized cost model that requires high volume to achieve low margins.

Similar problems surface with the distribution of 3 and 5 gallon bottles through supermarket and wholesale club stores. “Centralizing” distribution does centralize costs and simplify bottle delivery and empty bottle pickup. It also reduces or eliminates many of the other problems associated with home/office delivery. Problems such as billing and collection, however, still remain, even though on a centralized, consolidated manner wherein the bottler invoices the supermarket and wholesale stores rather than invoice individual home and/or office customers. One solution to the invoicing issue is to rely on the retailer to electronically transfer funds directly and automatically. This has become increasingly popular with the advent of e-commerce.

In this particular model of distribution, the customers serve themselves and prepay for the battled water products, and often prepay for the bottles as well, at a central location instead of being invoiced separately at dispersed locations for the delivered bottle water purchase and/or cooler rental. One of the drawbacks of this model is retailer control over hours of operation and location that limits customer access to water bottles.

As an added difficulty/inconvenience, the customer must carry/handle the product to a certain extent in order to get the 3 or 5 gallon bottle to their vehicle from inside the store. Such purchases are often performed simultaneously with shopping for other items inside the store, (depending upon whether it's a grocer or retailer—this can be a significant limitation), that only adds to the inconvenience. And often times, this will result in a separate trip back and forth to the vehicle and back and forth to customer service to return empties, and in some cases, to receive a voucher to present to a cashier as a credit against the purchase of a new bottled water product and then again out to the vehicle (or continue to shop inside the store before travelling back to the vehicle). This can have the unfortunate effect of limiting sales brought about by the inconvenience inherent when large water bottles are purchased.

This model of distribution thus has significant temporal and convenience limitations as it relies entirely on the individual store hours and on the location(s) of the stores. A further inconvenience and limitation is based upon the location(s) inside stores where bottles are returned and where bottles are purchased and retrieved. Added to this is the common practice of using vouchers to confirm bottle returns for a return-bottle credit, which, if lost, cannot be used to obtain a credit against a subsequent purchase of a filled bottle.

A substantial reason why water bottles are sold in stores is due to the effect of climate and weather on water. If left exposed to the elements—even in sealed containers—water can freeze and/or overheat. In the alternative, even if the bottled water were to be stacked outside the store on the sidewalk (so to speak) for purchase, it would still have to be brought back into the store at closing to reduce the risk of theft and to prevent freezing in colder climates. By way of example, there can be as many as 75-100 bottles stacked on the shelves of wholesale clubs. If not left inside the store, but displayed for sale outside, the bottles would need to be taken in each and every night absent some form of security measure such as a security fence with a locked door/gate. It should come as no surprise that water bottles sold by wholesale clubs are more likely to sell than bottles from store racks/shelves inside the club facilities.

Not only does this model create extra effort and handling for the customer, just as importantly, it places a constant burden on the retailer as it can involve the ongoing and tedious tasks of price-labeling, of handling the piles of empties and of planning the use of valuable floor/shelf space in designated “water aisles” such as those found in a supermarket or a Wal-Mart store. The same burden is experienced when the bottles are placed on separate shelving or pallets in retail stores such as Home Depot, or Lowe's, or in food clubs such as B.J.'s Wholesale Club, Sam's Club, Costco, etc. These problems are exacerbated by the fact that these self-serve products weigh about 44.5 lbs. per five gallon bottle and about 25.5 lbs. per 3 gallon bottle. This creates significant handling logistics for both the consumer and the store. For example, a 5 gallon bottle typically takes up an 8″ D−10½″ D×13″ H space for a 3 gallon bottle and an 11″ D×20″ H space for a 5 gallon bottle. Sales of, and even profits derived from, this product can sometimes be negated by the extra handling and “shelf-space” required.

Several other problems involving this distribution model are not readily apparent. For example, in the case of a grocery store, the customer must carry the 45 lb. or 25 lb. bottles around the store in a grocery cart, wait in line for a check-out clerk and then bring the bottle out to his or her vehicle, sometimes in inclement weather conditions and across a parking lot, to their parking space location that could be several hundred feet or yards away.

This scenario is equally relevant to wholesale and retail store locations and may be worse because the customer must park their car; bring any empties to the “customer service area” to redeem their deposit(s) and get a receipt; go to the cashier (wait in another line); pay for a new bottle(s) of water; go to the location where the 3's and 5's are kept; pick up the purchased bottles; place them in a basket carrier and then wheel them out to their vehicle, much the same as in the supermarket model. This is not the most customer friendly or convenient delivery model and again can stifle sales because many, if not most, shoppers at supermarkets are consumers doing their weekly shopping. In this scenario, buying drinking water in large quantities is not necessarily a “destination,” or “convenient purchase.”

In an improved form of distribution, 3 and 5 gallon bottled water can be distributed during and outside normal business hours in a vending machine designed to handle both 3 and 5 gallon sizes of bottled water and similarly sized empty returns. This is accomplished by using a single apparatus, located outside a retailer's store on a sidewalk, “end-cap”, or some other similar, customer-friendly location where customers can drive up, buy and return their bottles (24/7) and leave. Alternatively, the customers can shop first if they choose, and then purchase their water on the way out of the store.

In this novel distribution system, customers aren't reliant on retailers' hours of operation; both the bottle return and the purchase of the product are in the same apparatus; and retailers can offer guaranteed FDA and Board of Health approved products “packaged” and not delivered “bulk.” With use of Applicants' novel apparatus, customers don't have to bring their own “clean and sanitary” containers. The apparatus provides a cashless transaction that should reduce, if not eliminate theft because the apparatus is maintained in a closed condition 24/7 except during lawful purchase events. The apparatus further provides a convenient method of payment for the consumer because one of three or four methods of payment may be offered. If cash is preferable, the system can accept a prepaid water card, which can be purchased from the retailer associated with the apparatus. This method of payment is also compatible with retailers' cross-promotion activities such as discount programs where the customer can receive discounts off their purchase with the use of apparatus-recognized, retailer-approved coupons and/or retailer “advantage” cards.

The vending apparatus is configured to include lighting adequate to impart improved nighttime safety and appearance as well as improved customer-friendly operating features. With applicants' novel apparatus, inventory re-supply can be maintained on an “on demand” basis as the apparatus includes wireless communication with the manufacturer and/or dispatch control center to report when the vending apparatus is low on inventory, or needs service. A “return bottle” well/window can, if need be, incorporate a vendor controlled reader for RFID or bar codes secured to the bottles and incorporating a Unique Identification Number (UID) acceptable only to that bottler's product bottles for the amount paid when first purchased.

With the use of Applicants' novel apparatus, many unnecessary and unwanted business expenses and inconveniences are now eliminated as further explained in this disclosure. The apparatus may also include clear, multilingual signage to assist customers with their purchases unlike some other models of distribution. The need for bookkeeping is essentially eliminated due to the apparatus' wireless and automated features for all parties concerned. The size and shape of the vendor machine is expandable or contractible with modular features that allow for customization based upon the location, and re-fill delivery costs.

There should be no building permits or other special permits/license fees required unlike some other types of vending and distribution apparatuses as Applicants' vending apparatus should meet all NAMA, ADA and U/L requirements. Although there are hundreds of various models and types of vending machines, almost all of those machines and kiosks sell “packaged/bottled” water or soft drinks and are “small pack” sizes, less than 3 gallon, and do not address the problems associated with selling larger 3 and 5 gallon size bottles.

Many currently available water vending machines are “unpackaged” bulk water vending machines that require the customer to bring their own “clean, sanitary containers”. These machines are heavily regulated on an individual location basis and require, in many cases, both local and state permits and licenses from boards of health, plumbing, building and wiring inspectors as well as local water quality agencies such as the California Department of Health; the Rhode Island Board of Health; the Massachusetts Department of Environmental Protection (DEP); the New York Department of Health; the Massachusetts Board of Health; the Licensing Board of Certified Operators. The disclosed vending apparatus eliminates these requirements because all necessary permitting issues are already addressed before the product is loaded into a truck to deliver to the vending apparatuses at their retail location(s).

With respect to return bottles, in two currently used self-service vending systems, the “Return Bottle” area is located generally in a customer service area located as one enters the retail store where the “return” is either put in a designated “Return Bottle Area” (loose and unconstrained) or in a “Return Bottle” enclosed compartment that accepts all bottles from all vendors and prints a “refund” slip to be cashed in when purchasing a new filled bottle at a location elsewhere in the store. It falls to the customer to push a grocery cart with their bottled water—bottles which can weigh as much as 45 lbs. per 5 gallon bottle and more, depending on the number of bottles purchased and the style of bottle used—out to their vehicle located some distance from the store exit. The disclosed vending apparatus eliminates these inconveniences and problems as well.

What is needed is an apparatus that accommodates large 3 and 5 gallon bottles and allows for the return of emptied bottles and the purchase of filled bottles from the same apparatus. What is also needed is an apparatus that can execute a retail sales transaction without the need for the presence of a merchant during normal business hours. These and other objects of the disclosure will become apparent from a reading of the following summary and detailed description of the disclosure as well as a review of the appended drawings.

### SUMMARY OF THE DISCLOSURE

Unless specified, as used herein, large-volume water bottles shall mean reusable water bottles holding one or more gallons of fluid. Also as used herein, “water bottle” defines bottles containing water, or fluids other than water. In one aspect of the disclosure, a combination vending/return apparatus includes a modular vending segment including preset graded conveyor assemblies for receiving filled water bottles for vending. The conveyor assemblies are positioned adjacent to a vending shelf that presents bottles for retrieval by customers. A locked vending door is situated in a front wall of the vending segment aligned with the vending shelf to allow customer access to the bottles and to prevent unwanted bottle removal. A credit/debit/prepaid card acceptor connected either by Ethernet, landline or wireless connection using a credible wireless provider, e.g., Verizon® or AT&T®, provides a means for a customer to make purchases and receive credits for returned bottles via an atypical credit card gateway, e.g., USA Technologies, etc. A completed electronic purchase transaction unlocks the vending door after which a customer can remove the purchased bottle from the apparatus. A bottle guide rail assembly and locking collars retain bottles on the conveyor assemblies in a controlled manner and allow incremental movement of bottles toward the vending shelf as purchases are made and bottles are removed.

In a return segment of the apparatus, a return chute is formed in a front face of the segment dimensioned to receive specific-sized bottle returns. A series of sensors and readers confirm the bottle type and identification information for processing a return credit to the customer's account. The combination vending segment and return segment provide one-stop complete bottled water paperless transactions other than printed receipts. In another aspect of the disclosure, the system includes access to 24/7 service to accommodate any issues resulting from a purchase/return event.

In another aspect of the disclosure, a conveyor-belt driven vending segment of a vending/return apparatus increases the number of bottles deliverable within a single apparatus. The conveyor belt assemblies can be configured in multiple rows, each of which includes a central geared bottom track in communication with a geared motor drive controlled by a central processor. The credit/debit/prepaid card acceptor sends signals to the central processor that further sends signals to the conveyor motor(s) to advance the conveyor to deliver a water bottle to a customer retrieval location. The location includes a sliding and lockable vending door for access to the purchased bottles, or a simple magnetic door lock. A shelf can be further included to enhance the convenience of purchasing multiple bottles.

In yet another aspect of the disclosure, a vending/return apparatus with a vending elevator system further increases the number of bottles deliverable from a single apparatus. Air operated, and/or electric actuators are provided to move a vending elevator along a minimum of a single horizontal axis per row, or at least two axes to received bottles positioned on multiple row and column conveyor assemblies.

In a further aspect of the disclosure, a front load and vend apparatus uses gravity fed conveyors to deliver purchased bottles to customers. The apparatus further allows vendors to retrieve returned emptied bottles from the front end from a conveyor superposed about the delivery conveyors.

In a still further aspect of the disclosure, a vending/return transaction system provides a means for conducting a paperless transaction to purchase and return bottled water and empty bottles, respectively. These and other aspects and objects of the disclosure will become apparent from a review of the appended drawings and the detailed description below.

### BRIEF DESCRIPTION OF THE DRAWINGS

FIG. 1 is a plan view of a vending/return apparatus according to one embodiment of the disclosure.

FIG. 2 is a side elevational view of the vending/return apparatus shown in FIG. 1.

FIG. 3 is a top plan view of a vending/return apparatus according to another embodiment of the disclosure.

FIG. 3A is a sectional view of a bottle guide according to one embodiment of the disclosure.

FIG. 4 is a side elevational view of a vending/return apparatus according to the embodiment shown in FIG. 3.

FIG. 5 is a perspective view in partial phantom of a bottle advancing assembly according to one embodiment of the disclosure.

FIG. 6 is a top perspective view in partial phantom of a vending shelf and bottle restriction frame according to one embodiment of the disclosure.

FIG. 7 is a plan view of an atypical credit/debit card acceptor and receipt printer according to one embodiment of the disclosure.

FIG. 8 is a plan view of an atypical credit/debit card acceptor and receipt printer according to another embodiment of the disclosure.

FIG. 9 is a top view of a conveyor assembly according to one embodiment of the disclosure.

FIG. 10 is a side elevational view of a vending segment according to a yet further embodiment of the disclosure.

FIG. 11 is a top view in partial phantom of the vending segment shown in FIG. 10.

FIG. 12 is a side elevational view of the vending segment shown in FIG. 10.

FIG. 13 is a top perspective view in partial phantom of a bottle control conveyor assembly according to one embodiment of the disclosure.

FIG. 14 is a side elevational view in partial phantom of the vending segment shown in FIG. 10.

FIG. 15 is a front elevational view of the vending segment shown in FIG. 10 combined with a return segment to form a vending/return apparatus.

FIG. 16 is a top view of the vending/return apparatus shown in FIG. 15.

FIG. 17 is a side sectional view of the vending/return apparatus shown in FIG. 15.

FIG. 18 is a front view of a yoke assembly according to one embodiment of the disclosure.

FIG. 19 is a front view of a yoke assembly pusher according to one embodiment of the disclosure.

FIG. 20 is a front sectional view in partial phantom of a vending elevator assembly of the vending/return apparatus shown in FIG. 15.

FIG. 21 is a front view in partial phantom of a return door for a return segment of a vending/return apparatus according to one embodiment of the disclosure.

FIG. 22 is a side elevational view of a return door according to the embodiment shown in FIG. 21.

FIG. 23 is a front view in partial phantom of a vending door of a vending segment of a vending/return apparatus according to one embodiment of the disclosure.

FIG. 24 is a top view of the vending door shown in FIG. 23.

FIG. 25 is a side elevational view of the vending door shown in FIG. 23.

FIG. 25A is a side sectional view of the vending door shown in FIG. 23.

FIG. 26 is a front elevational view of a modular return door frame according to one embodiment of the disclosure.

FIG. 27A is a system flow chart for retrieving and returning water bottles, and conducting a paperless transaction for the purchasing and crediting sales/return transactions according to one embodiment of the disclosure.

FIG. 27B is a continuation of the system flow chart of FIG. 27A.

FIG. 28 is a side sectional view of a vending/return apparatus according to another embodiment of the disclosure.

FIG. 29 is a front sectional view of a vending apparatus according to the embodiment shown in FIG. 28.

FIG. 30 is a side sectional view of a vending apparatus according to a yet further embodiment of the disclosure.

FIG. 31 is a perspective view of a vending door according to another embodiment of the disclosure.

FIG. 32 is a side sectional view of a vending apparatus according to a yet further embodiment of the disclosure.

FIG. 33 is a side sectional view of the embodiment shown in FIG. 32.

FIG. 34 is a side sectional view of a further embodiment of the disclosure along with views of the top, back and front.

FIG. 35 is a side sectional view of a yet further embodiment of the disclosure.

### DETAILED DESCRIPTION OF THE DISCLOSURE

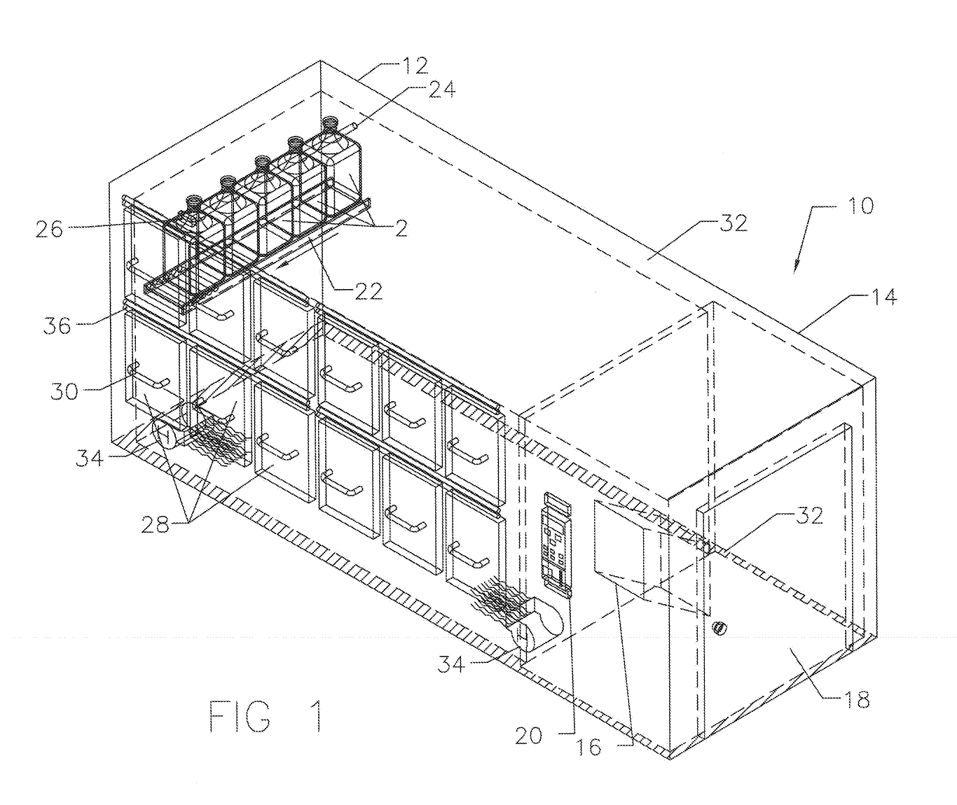

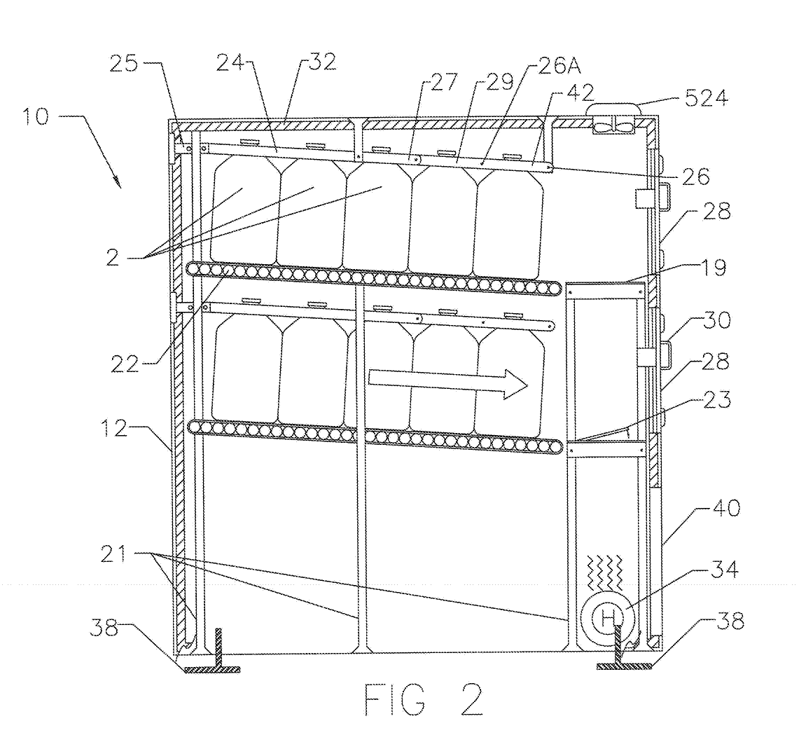

In one aspect of the disclosure as shown in FIGS. 1 and 2, a combination vending/return apparatus 10 includes a bottle vending segment 12 and bottle return segment 14. Return segment 14 includes a return chute 16 for receiving empty bottles. A sensor (not shown in FIG. 1) is situated inside the chute face to sense the delivery of an emptied bottle to commence a credit transaction described hereinbelow. Emptied bottles slide down chute 16 and become deposited in return segment 14. A return door 18 allows vendor access to the return segment space to retrieve emptied bottles for further processing, refilling, etc. A credit/debit/pre-paid water card acceptor 20 provides an electronic interface between apparatus 10 and a customer to process vending/return transactions. The details of acceptor 20 are described further herein.

Vending segment 12 includes a series of gravity-feed, roller-type conveyor assemblies 22 that permit loading and unloading of bottled water. Assemblies 22 are graded to urge bottles towards the front of segment 12 as shown in FIG. 2. The grade angle can range from about 1° to about 20°. Assemblies 22 are dimensioned to handle specific sizes of bottles. The dimensions are modified as needed to accommodate a wide range of bottle shapes and sizes including, but not limited to, rectangular and cylindrical. Positioned between a front edge of assemblies 12 and the front wall of segment 12 is vending shelf 19 configured to be substantially horizontal and substantially orthogonal relative to the front wall. A flapper switch 23 is positioned to extend upwardly from shelf 19 so as to be depressed and triggered by the presence of a water bottle on shelf 19. Both the conveyor assemblies 22 and vending shelves 19 are secured to and supported by an apparatus frame structure including framing members 21.

To ensure the horizontal and vertical surfaces of, and orientation of, apparatus 10 are plumb and level, threaded leveling pads 38 are positioned at the corners and alternatively at other selected areas of the bottom of apparatus 10. Each pad 38 is torqued to ensure proper and even weight displacement of apparatus 10. Should the apparatus be placed on an uneven or graded surface, pads 38 are raised or lowered as needed to ensure the horizontal and vertical surfaces of the apparatus are level and plumb, respectively.

Filled bottles 2 are loaded into apparatus 10 from the front of the apparatus by opening vending doors 28 (described more fully below) aligned with each vending row, and by disengaging a locking collar 26 (also described more fully below), and pivoting in an upward direction a bottle guide rail assembly 24 from a pivot hinge 25. In an alternative embodiment, the entire front panel of segment 12 can be configured as a door to allow access to all vending rows with a single door. Bottles 2 introduced into a row are urged back by each successive bottle loaded onto the row until the inner rear wall of the apparatus is engaged by the back-most bottle. Once a row is fully loaded with bottles, bottle guide assembly 24 is pivoted in a downward direction so as to place locking collar 26 in contact with the front edge of the front-most bottle's neck portion.

Each row includes bottle guide 24 to keep loaded bottles aligned with conveyor assemblies 22. Bottle guide 24 includes a pair of substantially parallel rails spaced to receive the mid-neck portions of the bottles. The spacing is adjusted to allow free movement of the bottles along the length of guide 24. A front end of each rail includes an articulating arm 29 that pivots about a locking hinge pin 27 mechanically operated and electrically controlled by the processor. Each arm 29 has at a proximal end, a locking collar 26 in the form of a magnetic pin that opens and closes with a solenoid device controlled by the processor. A second pin 26a is positioned in arm 29 so as to come into contact with the second-most forward bottle and directly arrests forward movement of the bottle adjacent the front vending end of segment 12. Bottles distal to the front two bottles are also restrained from advancing along conveyor assemblies 22 by resting against the front bottles.

The pins are operated sequentially. The front pin is released first to allow the first bottle to travel onto the vending shelf and then closed with the second pin opening thereafter to allow the second bottle to travel down the conveyor until it comes into contact with the front pin. The bottle immediately behind the second bottle migrates via gravity or power assist into the second bottle slot or position. Each bottle thereafter makes a similar incremental shift toward the first position.

Aligned with each conveyor assembly is vending door 28. As shown in FIG. 1, a plurality of doors 28 may be arranged in a series of rows and columns to correspond with rows and columns of conveyor assemblies 22. Vending door 28 can be made of any resilient material such as aluminum, steel and/or any high-density polymer products well known in the art. In one embodiment, Lexan® in a bluish color version is used for its ultraviolet light protection qualities. Shielding the bottles from UV light penetration is an important consideration in the selection of materials for the door as well as the entire unit to prevent bacterial formation or algal growth that can occur by constant exposure to direct sunlight. The opacity of the other disclosed materials serves the same function.

Each door 28 includes a handle 30 to allow a customer to open the door to retrieve a bottle after a payment transaction has been completed as described below. An electronic door latch (shown in FIG. 2) for each door 28 maintains each door in a locked configuration to secure the bottles from unwarranted removal.

To unlock a vending door, a customer must first use a credit/debit card, or prepaid-water card to institute a credit/debit transaction with acceptor 20. Once a payment transaction has been completed successfully, a processor (not shown) selects a vending door to unlock based on the availability of bottles in a particular vending row. Sensors, such as photocell 42, strategically placed throughout apparatus 10 provide feedback as to the quantity and location of bottles in the apparatus. The customer is given a visual signal at each door, and/or audible message on a screen and/or via a speaker system built into apparatus 10 and connected to the processor. The message informs the customer which door has been selected. The processor then sends a signal to disengage locking collar 26 that rotates upwardly to release the front-most bottle that travels onto vending shelf 23. Once on the shelf, bottle 2 depresses flapper switch 23, which, in turn, unlocks the adjacent vending door 28 and sends a signal to the processor to re-engage locking collar 26. It should be understood all electronically manipulated components of the vending/return apparatus are controlled by the central processor.

After locking collar 26 has been re-engaged, the second pin 26 is opened to allow the formerly second-most forward bottle to travel forward on the conveyor via gravity until the previously second-most forward bottle occupies the space formerly occupied by the first-most forward bottle. Since this is “gravity fed,” the remaining bottles shift forward accordingly. The presence of the front-most bottle on the shelf that remains stationary provides an auxiliary second physical barrier to prevent the other bottles from being released onto the shelf until the front-most locking collar is re-engaged. In an alternative embodiment, one or more rollers can be electrified or motorized to assist the gravity-feed system. If power rollers are used, conveyor assemblies 22 may be configured in a substantially horizontal orientation in lieu of being graded to enable the “gravity fed” feature. However, this could add substantial cost of manufacturing to the vendor unit and add to the mechanical complexity and maintenance complexity.

To complete the bottle retrieval process, the customer grabs handle 30 and opens the door to retrieve the available bottle. Once the bottle is retrieved, flapper switch 23 returns to its start position for the next vending cycle and sends a signal to the processor to lock the door. Spring actuation urges the opened door to the “closed” position after being released by the customer, which allows the electronic latch to be placed in a locked condition. It should be understood and appreciated by those having skill in the art that flapper switch 23 can be substituted with pressure and/or light sensor switches to determine the presence of a bottle on vending shelf 23.

To better assist the customer with the purchase in any light conditions, lights 36 are positioned over each door. Lights 36 may be maintained in an “on” condition are triggered via a switch operated by vending door 28. In the latter embodiment, lights 36 turn on when door 28 is in an “open” configuration. When door 28 is closed, a surface of the door contacts and depresses the switch to turn off light 36. A light may further be provided over acceptor 20 to provide lighting assistance to a customer operating credit card acceptor 20. This light too, may be controlled to operate only when acceptor 20 has been engaged.

Because apparatus 10 may be placed in a wide variety of geographic locations with substantially different weather patterns and climates, apparatus 10 is configured to be a climate-controlled unit. Foam insulation (or an equivalent type of insulation) 32 lines substantially all inner walls, ceiling and floor of apparatus 10. Foam and/or fiberglass insulation may be used for this purpose. Heating units 34 are controlled by the processor to maintain the inside temperature of apparatus 10 at a pre-selected temperature in cold climate conditions. Heating units 34 may be thermostatically controlled, atypical fan-type electric heaters or even the implementation of solar powered heaters. An optional access door 40 may be included in the front, side and/or back of the apparatus to allow access to the mechanical systems including the heating and cooling systems and for loading and unloading the three and five gallon bottles.

In warm climate conditions, an air conditioning unit (now shown) is incorporated into apparatus 10 and operated by the processor. Again, the inner temperature of apparatus 10 is maintained at a preselected temperature. It should be understood that apparatus 10 can be configured with both heating and air conditioning elements to provide year-round climate control of the apparatus.

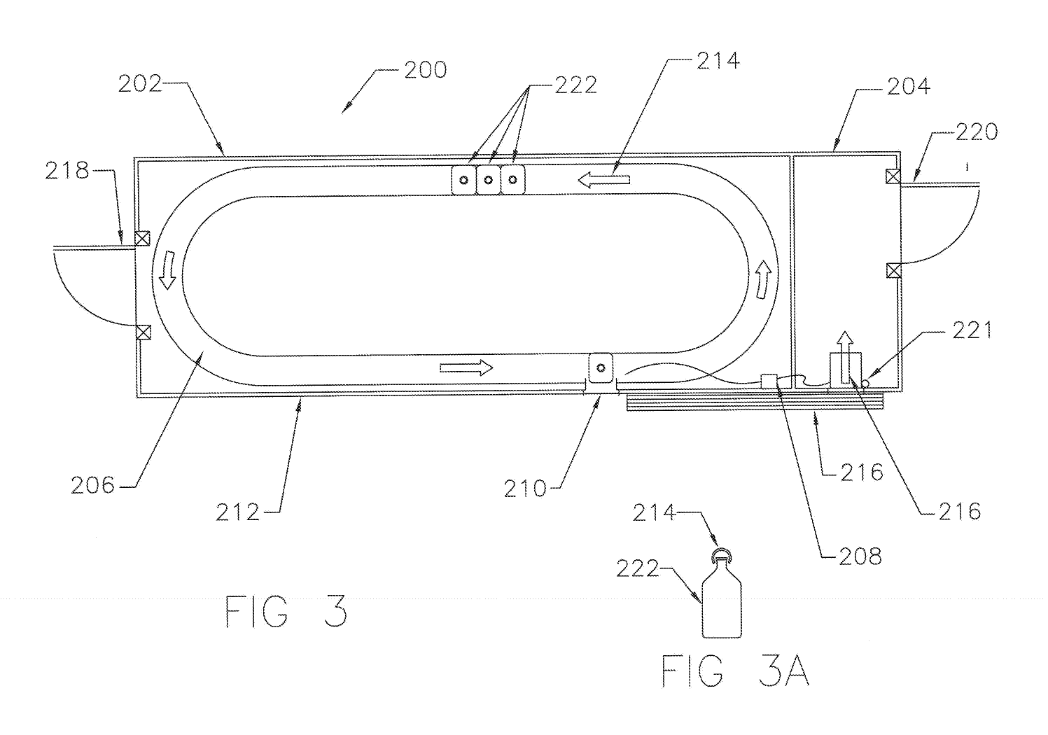

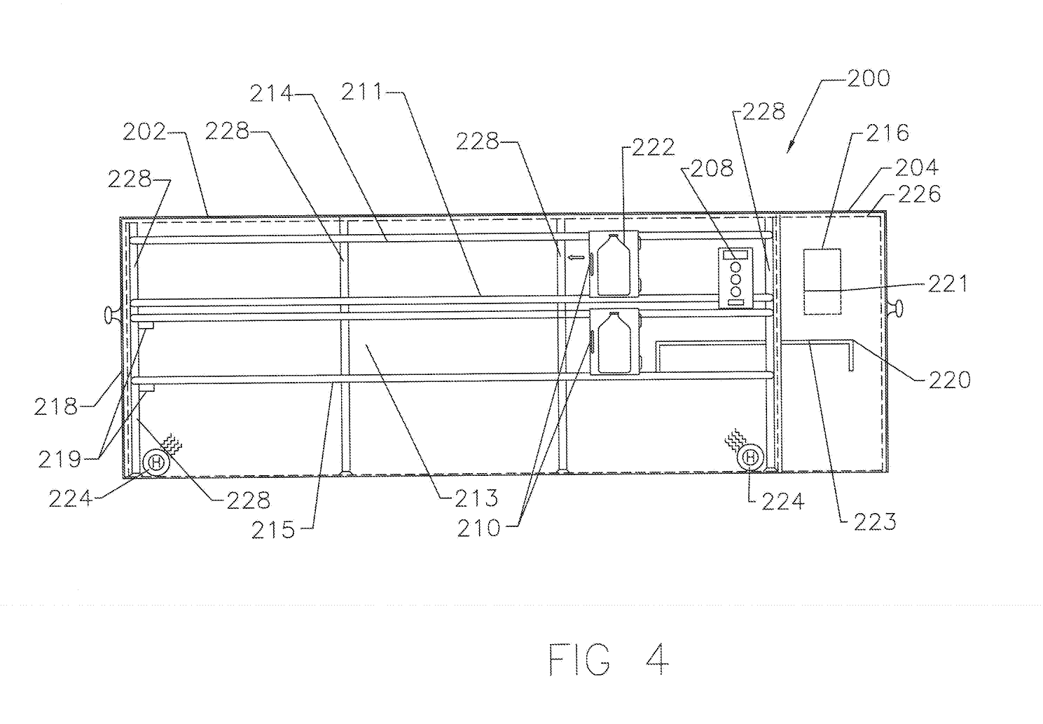

In another aspect of the disclosure as shown in FIGS. 3, 3A and 4, a conveyor belt driven bottle delivery system provides an additional bottle delivery option that increases the number of bottles storable in the apparatus within a given set of apparatus dimensions. The vending/return apparatus shown generally as 200 includes a modular vending segment 202 and a modular return segment 204. Making each segment modular facilitates delivery of the units meant to be stationary so as to maximize the number of units that may be carried by a single transporter. The design also improves ease of construction.

It is one aspect of the disclosure to keep the dimensions of the vending machine within “transportable dimensions” to allow transport by rail, box truck, or flat-bed (“low-boy”) type trailers. Over-the-road regulations control the widths and heights of these dimensions and can have significant impact on end-destination costs from their original point of manufacture. It is also to be understood that the design of the vending apparatus for both the “vending” side and the “return bottle” side can be contained within a single enclosure for ease of manufacturing and shipping.

Vending segment 202 includes one or more conveyor belt assemblies 206, stackable, to receive and vend large bottles of water. The apparatus may be configured to dispense bottles sized from about 1 liter to about 5 gallons. A plurality of frame members 228 supports the conveyor assemblies throughout the apparatus. In a multiple conveyor embodiment as shown in FIG. 3, a top conveyor 211 is driven by a motor 219 having a geared shaft that engages a geared track formed or attached to a bottom of conveyor 211. Motor 219 may be a 3 hp 120 v motor with a geared shaft and is controlled by the processor described herein.

A bottle guide 214 is positioned above top conveyor 211 substantially in vertical alignment with a centerline of conveyor 211. Bottle guide 214 is dimensioned to receive the top ends of bottles carried by conveyor 214 so as to allow free movement of the bottles within the guide, but with sufficient restriction to prevent lateral displacement and tipping of the bottles while travelling on the circling conveyor 211. Guide 214 may be constructed from 4 inch PVC piping cut along a chord less than the diameter of the piping so as to have a cross-section profile larger than a semi-circle. The inward curvature of the cut piping edges provides an arresting surface that engages a bottom edge of a bottle top lip. The PVC material is sufficiently lubricious to permit the unimpeded movement of the bottles along guide 214.

Guide 214 may be either suspended from a top of vending segment 202, or secured to the frame elements. To accommodate different height bottles, guide 214 may be either set to a specific distance from conveyor 214, or attached to an adjustable series of posts to allow guide 214 to be raised or lowered depending upon the bottle size used for the particular conveyor.

If one or more additional conveyor assemblies are used, such as lower conveyor assembly 215 shown in FIG. 4, the assemblies are aligned substantially laterally and vertically with top conveyor 211. A lower bottle guide 213 performs the same function as guide 214 for bottles on lower conveyor 215. Guide 213 is secured to the frame elements and may be either set at a specific distance from conveyor 215 to accept one bottle size, or adjustable to accommodate a plurality of sizes. The means used to allow adjustability may be telescoping supports, segmented supports and the like.

The conveyors are housed in an enclosed structure made from polymeric material sheets or sheet metal, such as sheet steel 212. The walls and top are insulated with about 1 to about 3 inches of foam core insulation 226. Additionally, the floor of the enclosure may also be insulated with insulation 226. Other insulation materials may be used as are commonly known in the art. To counter freezing conditions, one or more heaters 224 are positioned in vending segment 202 and operated by the processor that also monitors temperature with a temperature sensor (not shown).

To access the conveyor system, at least two access doors are provided. A lockable service door 218, situated at a distal end of vending segment 202, provides access to the conveyor assemblies to load filled bottles. Motors 219 are situated in close proximity to door 218 and include manually operable start/stop controls to enable a user to load bottles onto the conveyor(s) and advance the conveyors to facilitate loading of additional bottles until the entire conveyor assembly is loaded with bottles.

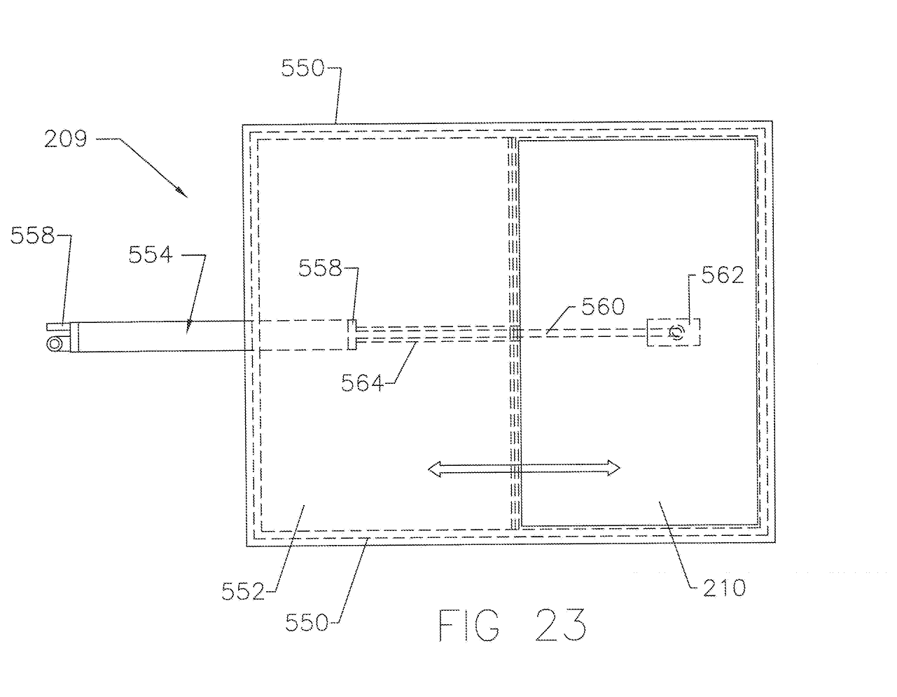

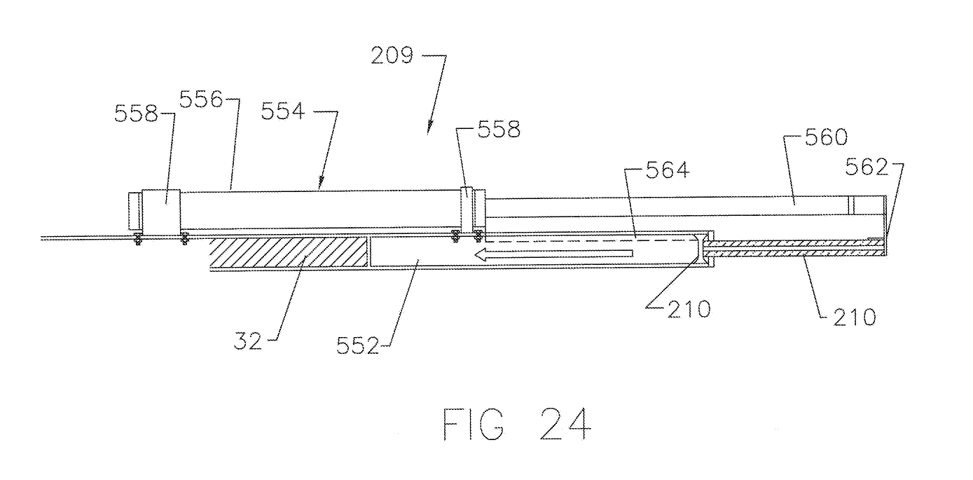

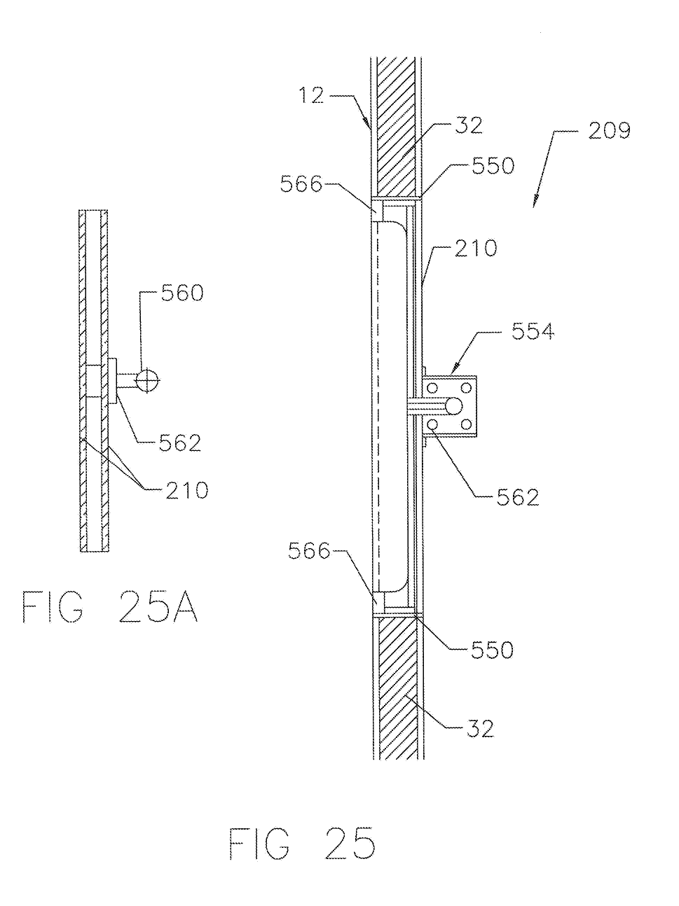

Referring now to FIGS. 23-25A, to allow customer access, a vending door assembly 209 including door 210 is positioned in a front wall of vending segment 202. In one embodiment, each conveyor assembly is provided with a dedicated door 210 positioned so as to align a bottom end of the door substantially with a top surface of an adjacent conveyor assembly. Each door 210 is secured to a pair of rails 550 that permit horizontal movement of the door from closed to opened positions. In one embodiment, the doors are configured to open to the left, away from the adjacent return segment 204. Door 210 may be a double layer of Lexan® (as shown in FIG. 25A), to provide an added measure of insulation for the door area.

In one aspect of the disclosure, rails 550 extend into a pocket 552 dimensioned to receive door 210 when positioned in an open state. A rubber seal/gasket 566 secured to a perimeter of door 210 ensures a substantially air-tight seal when the door is positioned in a closed state. This ensures that any air conditioning (cooling and/or heating) of the internal atmosphere of apparatus 10 is maintained when door 210 is closed.

To electro-mechanically manipulate door 210, a door operating assembly 554 includes a linear actuator 556 secured to an inside of the front wall of apparatus 10. Actuator 556 is electrically connected to the processor and secured to the wall with mounting brackets 558. Extending laterally from actuator 556 is actuator arm 560. A distal end of arm 560 is secured to door 210 with door mounting bracket 562. If needed, a slot 564 is formed on the inside of the front wall to provide a clearance channel for arm 560 to slide and/or retreat and extend within.

Although door assembly 209 may be mounted and secured to the front surface of the front wall of apparatus 10 (with brackets 550 secured to the front surface), use of pocket 552 is an improved configuration as a security means to prevent unauthorized access to apparatus 10. Operation of door assembly 209 is controlled and coordinated with purchases by the processor as disclosed herein.

Door 210 is configured to be locked electronically. Successful completion of the financial portion of the transaction precedes the door being unlocked via a solenoid, or solenoid-like device controlled by the processor, which then initiates operation of actuator 556 to open and close door 210. The number of bottles purchased and permitted to be removed from the conveyor is controlled by individual locking yolks secured to each bottle. The processor unlocks each bottle in succession until the purchased number has been taken by the customer. Removal of a bottle can be confirmed by any number of means such as broken light beams, pressure sensors and the like. It is in the spirit of the disclosure that any detection means, known in the art, may be used to ascertain when a bottle has been removed by a customer.

Positioned in close proximity to door(s) 210 is vending shelf 223. Shelf 223 may be constructed from polished aluminum, or any weather-resistance material, such as fiberglass. Shelf 223 provides an accommodating surface to temporarily hold bottles for a multiple bottle purchase, or for a customer to temporarily place other items, e.g., shopping items, while making a purchase.

Referring again to FIGS. 3-4, return segment 204 is shown as a modular unit attached to vending segment 202. Segment 204 is essentially an enclosure for receiving used bottles for cleaning and reuse. As each bottle is provided with a serial number, a vendor can keep track of the bottle's use and recycle it after its intended lifespan. It should be understood that although the apparatus is described as vending reusable bottles, the apparatus may also be used with disposable bottles and adjusted to accommodate a variety of sizes of disposable bottles. If the apparatus is structured to vend disposable bottles, return segment 204 can be used to deposit disposable bottles for recycling.

Segment 204 includes a bottle return aperture 216 configured to match the cross-sectional dimensions of the bottles 222 offered in the vending segment. This ensures bottles returned to the return segment are bottles owned by the particular vendor that monitors the bottles with coded unique identification numbers. Bottles offered by other vendors having different dimensions will not be accepted in the return segment 204 and/or will not receive a credit without a properly authorized and recognized identification number.

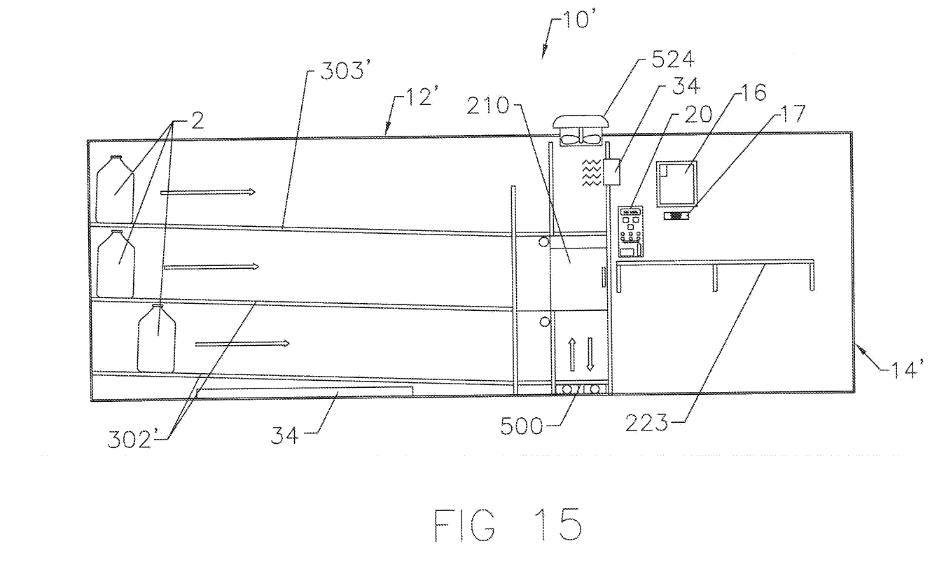

Referring again to FIG. 1, a sensor, or sensors, (not shown in FIG. 1) situated inside the chute face acts to sense the delivery of an emptied bottle to commence a credit transaction described hereinbelow. A barcoded UID and/or an RFID UID tag is located on each bottle that identifies the exact vendor and individual bottle and the code is read by an atypical barcode reader device, or an atypical RFID device. The reading device 17 can be placed inside the chute, or on the surface of apparatus 10 as shown in FIG. 15.

All “tags,” whether barcode or RFID, are to be waterproof and abrasive proof so as to survive approximately 40-50 re-uses involving high temperature wash/rinse cycles and constant handling. Once read, the empty bottles slide down chute 16 and become deposited in return segment 14. A return door 18 allows access to the container space defined by the return segment to retrieve emptied bottles for further processing, refilling, etc. A credit/debit card acceptor 20 provides an electronic interface between apparatus 10 and a customer to process vending/return transactions. The “reimbursement” for the previous purchase of the bottle is not credited to the customer card until the barcode/RDID is identified as one belonging to the proper manufacturer and then “credit” is posted. This process assures against receiving unacceptable bottles from some undesired source. The details of acceptor 20 are described further herein.

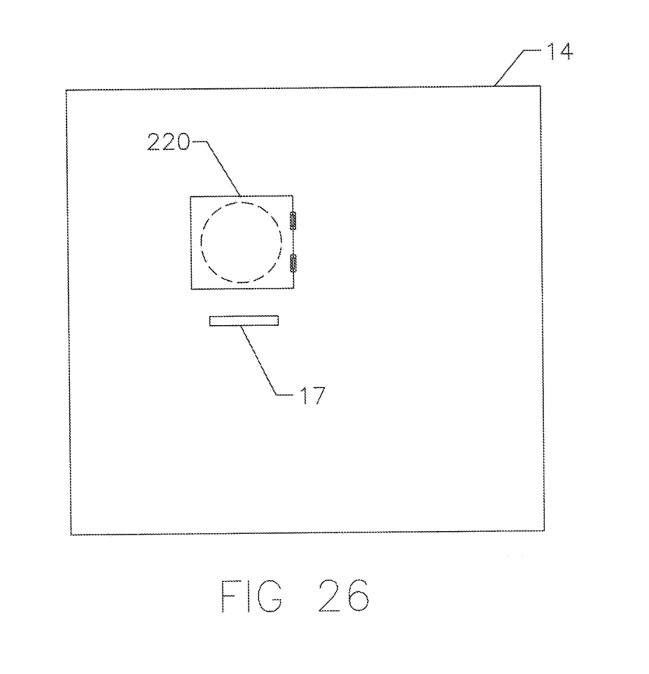

Referring back to FIG. 4, to facilitate deposit of emptied bottles, a chute 217 may be appended to the inside of segment 204 so as to provide a smooth transition from aperture 216. Aperture 216 may be constructed with a modular frame that can be exchanged with other frames of different dimensions to accommodate differently-sized bottles, such as shown in FIG. 26.

Situated in close proximity to aperture 217 is one or more sensors 221 for detecting the presence of a return bottle being deposited in segment 204. Sensor 221 may be any well known in the art including, but not limited to, RFID reader, mechanical, optic, photoelectric, etc. Multiple sensors may be used and positioned to ensure a positive read of a unique identification number positioned on bottle 222. The identification number may be secured to the bottle in any number of methods including tag, laser engraving, sticker and like methods. Sensors 221 may also be configured and arranged so as to determine the dimensions of the bottle being deposited to ensure the bottle is a vendor-approved bottle.

A further purpose of the sensors is to send a signal to the processor to create a bottle deposit credit as explained more fully below. By reading the unique identification number, one credit transaction is created regardless whether the attempt to deposit the bottle requires more than one try. This ensures a customer receives only one credit per bottle returned.

To enable a vendor to retrieve the returned bottles, a return door 220 is provided to allow access to the inner chamber of return segment 204. Return door 220 is shown attached to a side wall of segment 204. Door 220 may also be positioned on a back wall, or a front wall without departing from the spirit and scope of the disclosure.

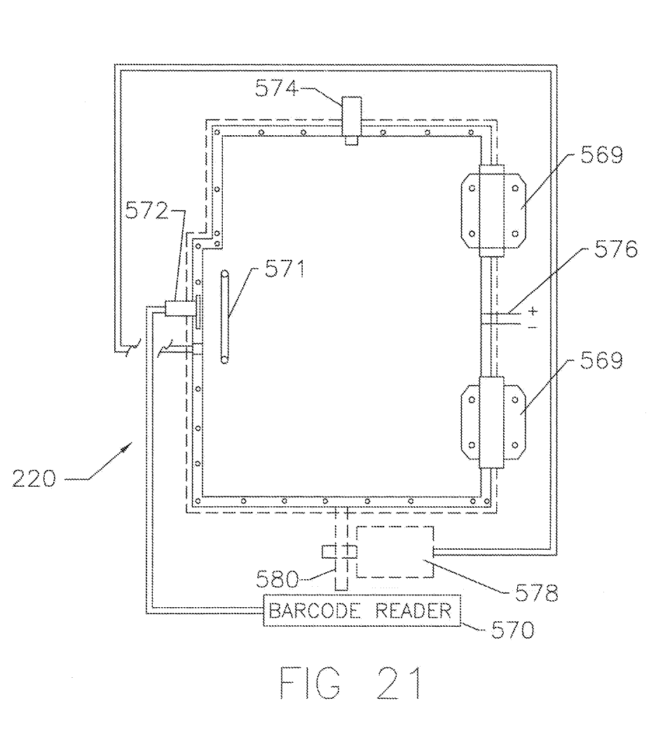

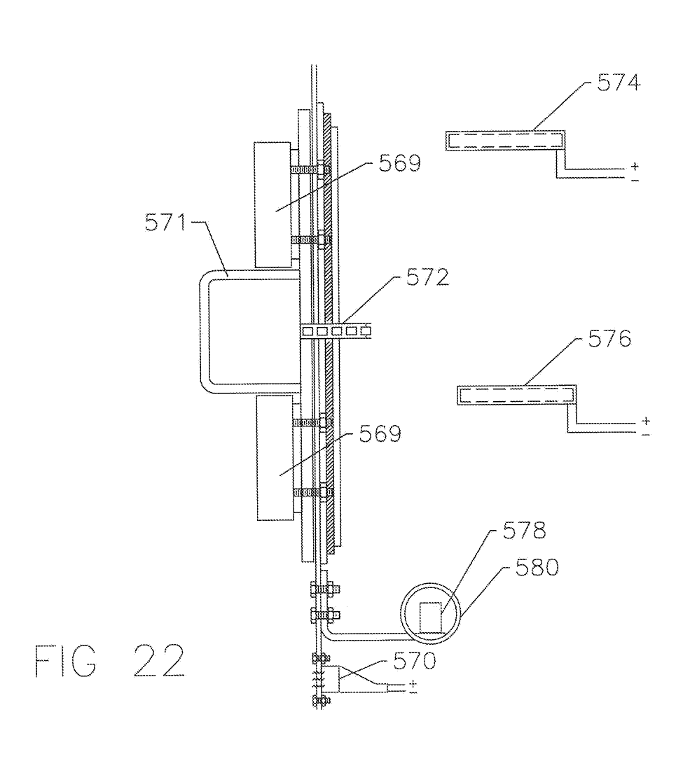

In an alternative embodiment shown in FIGS. 21, 22 and 26, door 220 is configured as a locked door that requires bottle authentication before being unlocked. The door is secured to the face of return segment 14 with spring loaded hinges 569 and includes handle 571 to facilitate door opening. A bar code reader 570 is positioned on a front of return segment 14 to read bar codes secured to vendor water bottles. Reader 570 may be electrically connected to the processor to enable a credit transaction for the return bottle as disclosed herein. The customer moves the bottle into close proximity of reader 570 so that the bar code can be read. If there is no bar code, or the bar code is not recognized by the system, door 220 remains locked.

As shown in FIG. 26, door 220 may simply include a modular chute opening that conforms to the shape of bottles currently being offered by the vendor. In this embodiment, a successful bar code read sends a signal to a solenoid, or like device to unlock door 220 and allow the customer to deposit the empty return bottle. Sensors in the chute area send a signal back to the processor to enable a credit transaction as disclosed herein.

In an alternative embodiment, door 220 may be combined with a motor-driven bottle feed mechanism to detect and advance the return bottle into return segment 14. In this embodiment, door 220 includes an electric lock 572, e.g., a squiggle lock, operated when an electrical signal is received from barcode reader 570. As shown in FIG. 21, the general opening shape as well as may be the shape of door 220 is configured to conform to the shape of the vendor's bottles so as not to allow insertion of unauthorized bottles. Once the door is opened, a return bottle is inserted into the opening, a first solenoid-based toggle switch 574 detects the presence of the bottle and sends a signal to the processor to perform the credit transaction. A second toggle switch 576 senses a bottle and sends a signal to a gear motor 578 that operates a rubberized or friction-imparting wheel 580 registered against the return bottle. Rotation of the wheel 580 urges the return bottle into return segment 14.

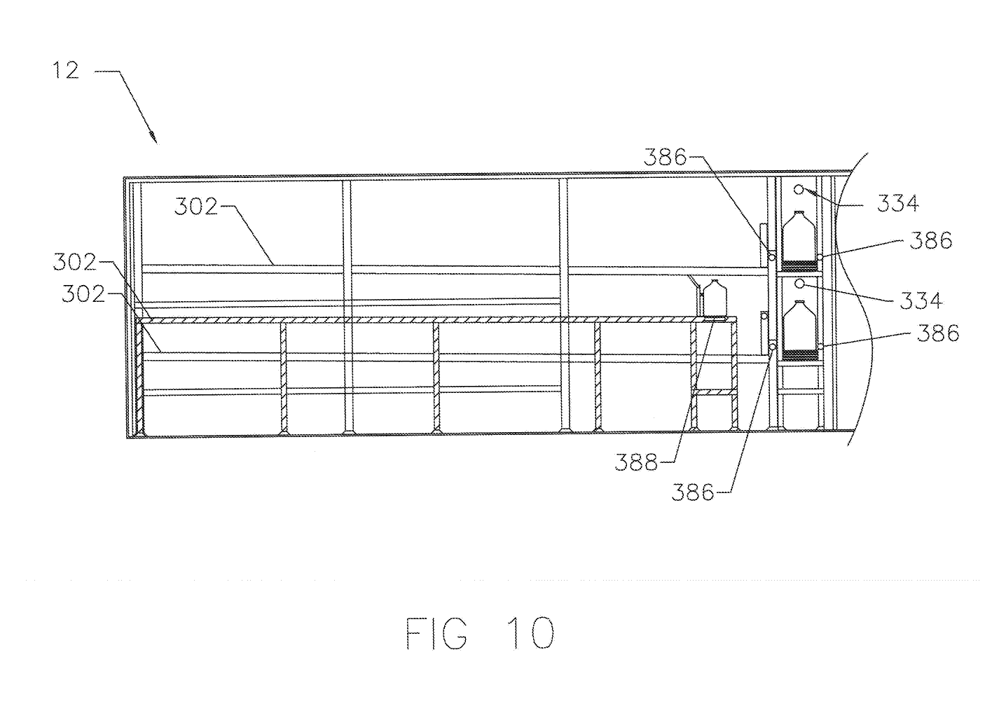

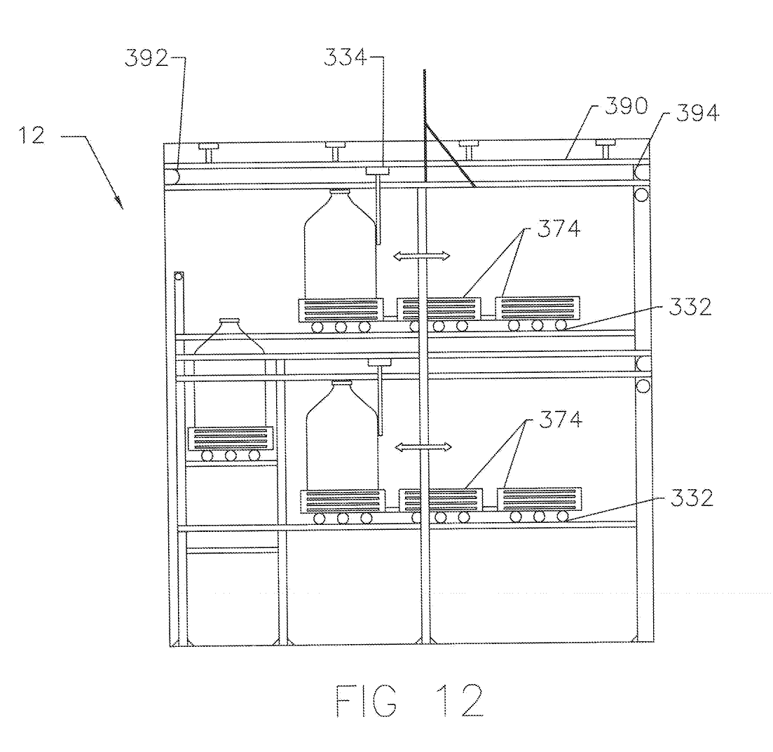

Referring now to FIGS. 10, 11 and 12, a further aspect of the disclosure is shown. In this aspect, vending segment 12 includes a plurality of gravity-feed conveyor assemblies 302 that feed bottles 2 into a substantially orthogonal vending conveyor assembly 332. This embodiment increases the number of bottles deliverable to a single vending door. The conveyor assemblies in this embodiment may occupy one or multiple horizontal conveyor rows as shown in FIG. 10. Each row has a dedicated vending door from which customers can retrieve purchased bottles.

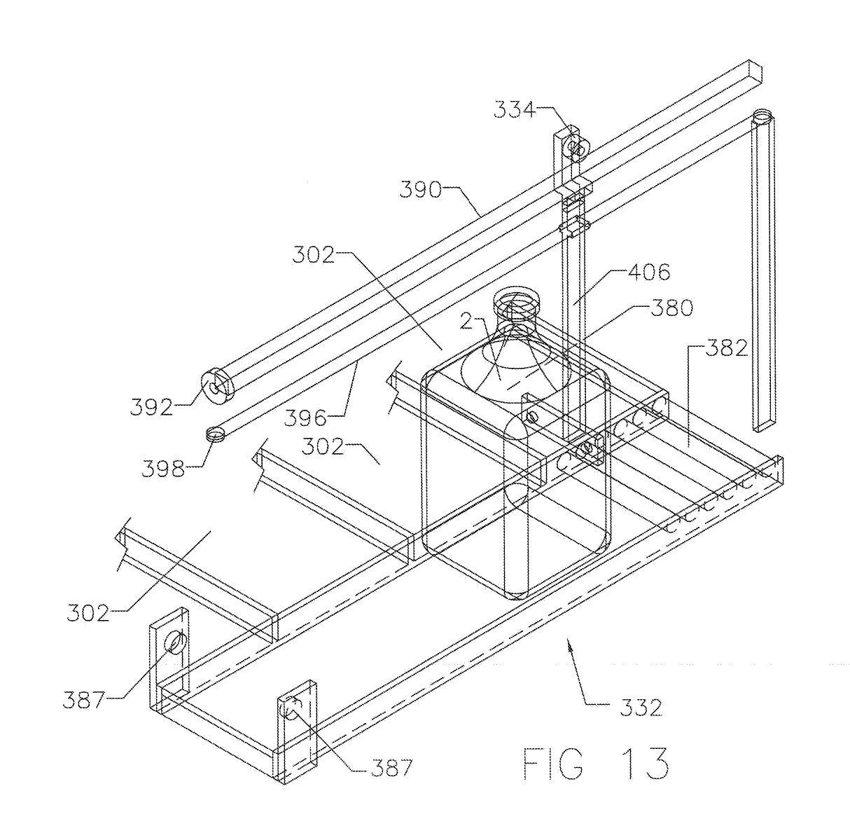

In this embodiment, a yoke system 334 (shown in FIGS. 13, 18 and 19) secured to a guide bar and cable system urges bottles along vending conveyor 332 toward the vending door.

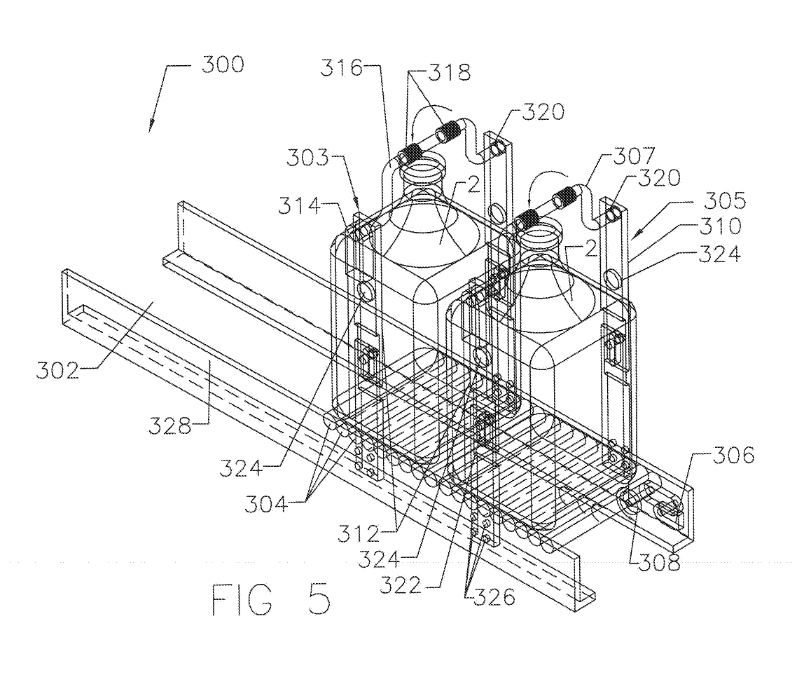

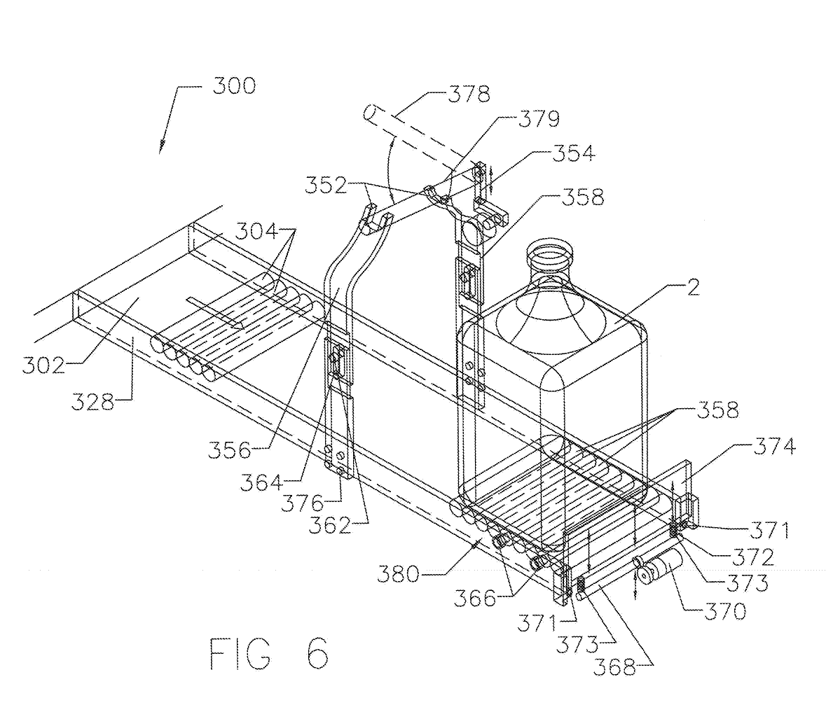

Referring now to FIGS. 5 and 6, a bottle advancement assembly and a locking/latch assembly, respectively, are shown that control forward movement of bottles along conveyors 302 onto vending conveyor 332 and allow controlled access to individual bottles when a customer attempts to retrieve a bottle during a purchase. Advancement assembly, shown generally as 300, includes a pair of locking frames fixed to a pair of conveyor rails 302 that support rollers 304.

As shown in FIG. 5, a front advancement assembly, generally referred to as 305, includes a rotating rod 307 used to urge a forward-most bottle toward the vending door. Rod 307 includes a pair of rollers 318, preferably rubberized, or made from a polymeric material to enhance contact with bottle 2 to ensure positive grip while urging the bottle forward. Rod 307 is designed to rotate 360° to perform repeat bottle movement functions with each revolution. The process begins with rod 307 in a substantially upward or vertical position as shown in FIG. 5.

Rod 307 is supported by a pair of substantially parallel support bars 310 and 312 positioned on opposing sides of conveyor 302. A base of each support bar is affixed to the adjacent conveyor rail via mechanical fasteners 326, welded joint and like methods. Each support bar includes a bore at an upper end into which a ball-bearing sleeve/bushing 320 is secured to allow free rotational movement of rod 307. Each support bar also includes an adjustable bracket plate secured to each bar with mechanical fasteners in a slot formed in each bar to allow the height of assembly 305 to be adjusted for different sized bottles. Telescoping support bars may also be used for this purpose.

Attached to support bar 312 is motor 322 that connects to an end of rod 307 to rotate the rod when a signal is received from the processor to rotate the rod to advance a bottle. Motor 322 may be a 90° offset gear motor, or any motor suitable to rotate rod 307 with sufficient torque to propel a filled bottle forward.

To assist rod 307, advance wheel 308 is set in front of, or among rollers 304. Wheel 308 is comprised of a rubber or like material to provide positive traction when contacting bottle 2. A roller motor 306 operates wheel 308 to propel bottle 2 forward. Roller motor 306 may be a 90° offset gear motor, or any motor adequate to urge bottle 2 forward toward vending door 210.

To detect movement and ultimate removal of the forward-most bottle, photocells 324 are positioned on support bars 310 and 312 and aligned to create a beam, which when traversed by bottle 2 breaks the beam and sends a signal to the processor. The processor then accounts for the removed bottle for inventory and accounting purposes.

A secondary advance assembly 303 is positioned distal to forward advance assembly 305 to advance the bottle immediately preceding the forward-most bottle. Assembly 303 includes a substantially identical construction to that of assembly 305 including support bars 310 and 312 with adjustable bracket plates secured with wing nuts or similar mechanical fasteners 326 in slots formed in the bars to allow adjustment for differently-sized bottles. Bars 310 and 312 are attached to conveyor rails with mechanical fasteners, welding or like method. Assembly 303 further includes secondary rod 316 with rubber or friction-imparting rollers 318 used to urge a second bottle 2 into the forward-most position previously occupied by the forward-most bottle, now removed.

Each support bar includes ball-bearing sleeve/bushing 320 to allow free rotation of rod 316. Secondary motor 314 is attached to bar 312 and attached to an end of rod 316 to operate the rod and move it in a rotational path to contact bottle 2, urge it forward, and then return to a starting position as shown in FIG. 5. Further advance assemblies are not required as bottles fill the second position when vacated by gravity feed.

Referring to FIG. 6, an alternative bottle advancement assembly is shown. In this embodiment, a locking/latch assembly 360 arrests forward movement of bottles on gravity-feed conveyor 302. On a forward side of assembly 360 is a bottle launch segment 380 that utilizes motor-driven geared rollers 366 and a spring loaded stop plate 374 to provide controlled delivery of bottles onto vending conveyor 332.

Assembly 360 includes a pair of substantially parallel support bars 356 and 358 positioned on opposing sides of conveyor 302. A base of each support bar is affixed to the adjacent conveyor rail via mechanical fasteners 376, welded joint and like methods. Each bar may be constructed as adjustable brackets with a first inner segment 362 having a pin, e.g., a threaded bolt, extending outwardly from the assembly. A second outer segment 364 includes a slot for receiving the pin. The segments have overlapping sections the register against each other and provide the necessary support to impart rigidity to the support bars. With the pin loose, the segments can be adjusted vertically to change the vertical height of the support bars to accommodate differently sized bottles.

Top ends of each support bar may be shaped to conform their collective shape to the cross-sectional profile of a bottle and its associated neck so as to reduce the distance between the support bars and consequently concentrate the force applied to the bottle at the point of contact. Each support bar includes a slot 352 at an upper end dimensioned to receive a restraining rod 378 that arrests movement of the bottles. Rod 378 is secured to an actuator 354 which, in turn, is secured to support bar 358. Rod 378 pivots from closed to opened positions from its point of attachment to actuator 354. In a closed position, rod 378 rests within slots 352.

The orientation of restraining bar 378 is controlled ultimately by the processor in communication with actuator 354. Commands received from the processor operate the actuator to set the position of bar 378 in either a closed or opened orientation. When bar 378 is in an open position, the lead-most bottle migrates onto launch segment 380 via gravity feed. Forward movement of the lead-most bottle, and any subsequent bottle that travels onto launch segment 380, is arrested by stop plate 374.

Vendor personnel may also operate stop plate 374 at the front ends of each conveyor row to temporarily arrest forward movement of bottles while the conveyor line is being loaded. It has been discovered that commonly sized 2 inch rollers do not allow fluid movement with cylindrically shaped bottles. Rollers having a 1¼ inch diameter closely spaced provide a more advantageous surface for rolling bottles toward the front end of the vending/return apparatus.

Launch segment 380 includes a series of common rollers 358. Interspersed between rollers 358 are one or more motorized rollers 366 controlled by the processor. A pair of slots 371 formed on an end of launch segment 380 are dimensioned to receive stop plate 374 which slides vertically within the slots and to ensure proper alignment throughout plate 374 vertical movement. Stop plate 374 may include a pair of tension springs 373 positioned toward each end of plate 374 with distal ends attached to a roll bar 368. Roll bar 368 includes a gear mated to a gear of a geared motor 370. Motor 370 is also controlled by the processor.

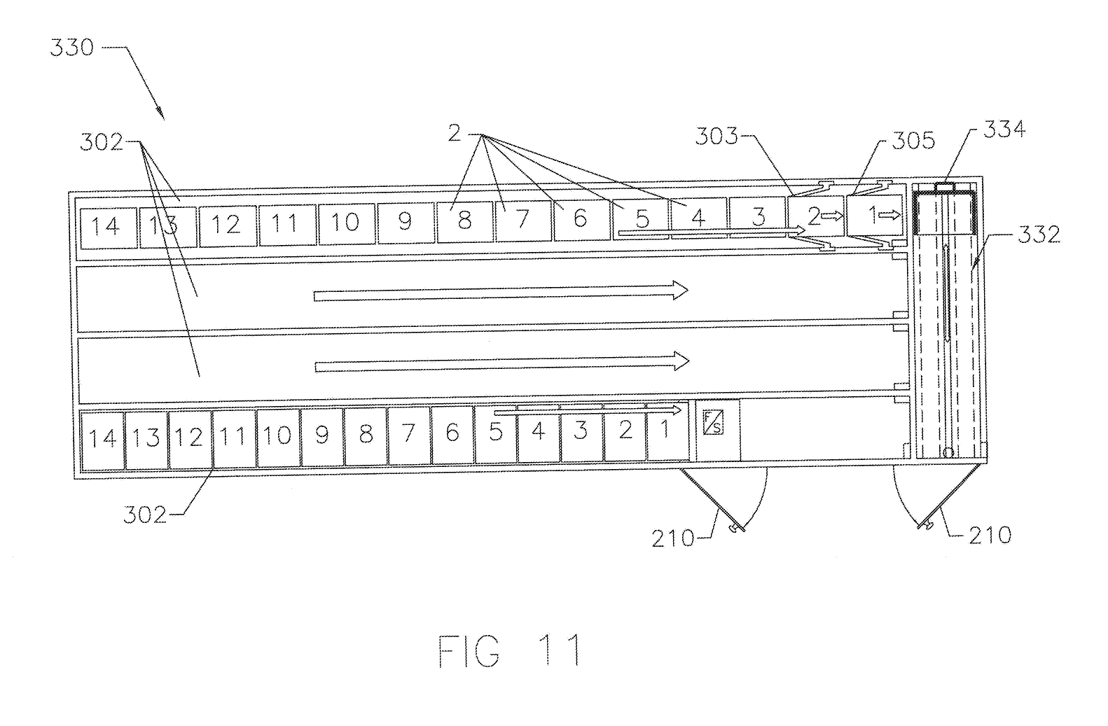

The operation of motorized rollers 366 and stop plate 374 are coordinated by the processor when a vending command is issued. The process begins with stop plate 374 being transitioned from an up, closed position to a down, open position. In the open position, a top edge of plate 374 is substantially level with the highest points of the rollers so as to allow free movement from the launch segment to the vending conveyor 332. Once in a down position, rollers 366 are activated to urge a resident bottle off of launch segment 380 and onto adjacent and substantially orthogonally oriented vending segment 332 as shown in FIG. 11.

In an alternative embodiment, a sheet surface may be used in place of the rollers to facilitate movement of bottles loaded onto the conveyor lines. In a yet further embodiment, the rails may be coated with a lubricous surface treatment, e.g., Teflon®, and act as support surfaces for the bottles to be placed and allowed to roll or migrate toward the front of the vending/return apparatus.

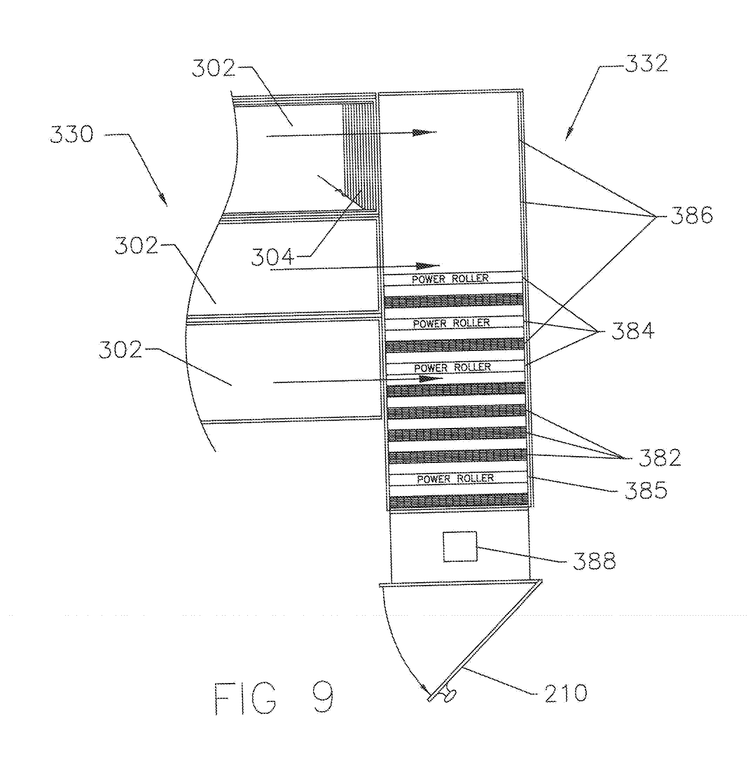

Referring now to FIGS. 9 and 13, vending conveyor 332 includes a pair of rails with a plurality of common rollers 382 and a plurality of power rollers 384, i.e., motorized rollers, secured between the rails so as to allow free rotation of the rollers. Power rollers 384 urge resident bottles toward a front of the vending apparatus toward door 210. A series of sensors 386 are strategically positioned in the rails to detect the presence of bottles coming from each conveyor 302. A sensor may be positioned to align with each conveyor 302 to ensure any bottles on the vending conveyor are sensed and accounted for by the processor that receives signals from the sensors.

When a vending transaction is processed, the processor initiates release of a bottle from one of the conveyors 302 onto the vending conveyor 332. The processor next signals motors connected to, or embedded within, each power roller 384 to begin rotation and urge the resident bottle toward the vending door 210. A modified power roller 385 may be situated in close proximity to the door end of conveyor 332 that can be controlled and used as a brake to arrest forward movement of the subject bottle 2. When bottle 2 arrives at the end of conveyor 332, it migrates onto and depresses a paddle switch 388 that activates the braking function of roller 385 (which occurs by virtue of rotating the roller in an opposite direction toward a back end of conveyor 332), and deactivates via the processor, or via direct connection, the door lock (not shown) that maintains door 210 in a locked position. The customer can then open the door and retrieve the bottle.

In a further aspect of the disclosure, as shown in FIGS. 10, 12, 13, 18 and 19, a yolk system 334 may be included to urge bottles on conveyor 332 toward door 210. The yolk system may be used in conjunction with the rollers of conveyor 332, or may perform the bottle movement function alone with either a conveyor constructed with rollers, or constructed with a smooth lubricious surface such as polished steel with or without a lubricious coating treatment such as Teflon®.

Yolk system 334 rides along a yolk rail 390 secured to the frame system of the vending segment 12. Positioned at each end of rail 390 are stops 392 and 394. Yolk system 334 includes yolk assembly 396, which includes a yolk frame 398 having shaft housings 400 formed on distal ends. Bearing shafts 402 are secured within each shaft housing 400 and rotate freely within the housings. Attached to each shaft 402 is a yolk wheel 404 each of which rotates freely and registers against opposing sides of rail 390. In an alternative embodiment shafts 402 are fixed to yolk frame 398 and yolk wheels 404 rotate freely about shafts 402. It should be understood that any combination of rotating shafts and/or rotating wheels may be used to produce the same function, i.e., to allow free movement of the yolk assembly 396 along rail 390.

Suspended downwardly from a proximal end of yolk frame 398 is yolk shaft 406. Shaft 406 may be welded to frame 398 or affixed via mechanical fasteners 408. A horizontal push bar 410 is secured to a distal end of shaft 406, again via weld or mechanical fasteners 412. Secured to the front surface of push bar 410 in substantial proximity to extreme ends are rubber stops 414. Stops 414 provide added cushion and grip when registering against a bottle being delivered to the front of the vending segment 12. The spacing of the stops assists maintaining bottles aligned with the direction of motion. As is well known in the art, however, the spacing may be altered to accommodate different sized bottles and different bottle configurations. For example, for cylindrical bottles, stops 414 may be positioned to engage tangential points on the bottle's sides to ensure the bottle does not rotate and drift out of alignment relative to the course of travel towards vending door 210.

Referring to FIG. 13, yolk assembly 334 is propelled along guide bar 390 via a geared motor 399 controlled by the processor. A pair of pulleys 398, positioned on the extreme ends of, and suspended above, the vending conveyor, guide a cable 396 attached to shaft 406. Signals received from the processor coordinate the position of yolk assembly 344 to receive the next bottle delivered onto the vending conveyor 332 to urge it forward toward door 210. A photocell 387 detects the presence of a bottle advanced to the front of the conveyor and sends a signal to the processor, which sends a signal to motor 399 to arrest forward movement. Yolk assembly 334 either remains positioned at the front until a new transaction is initiated, or is returned to the backmost position in a “ready” mode for the next transaction.

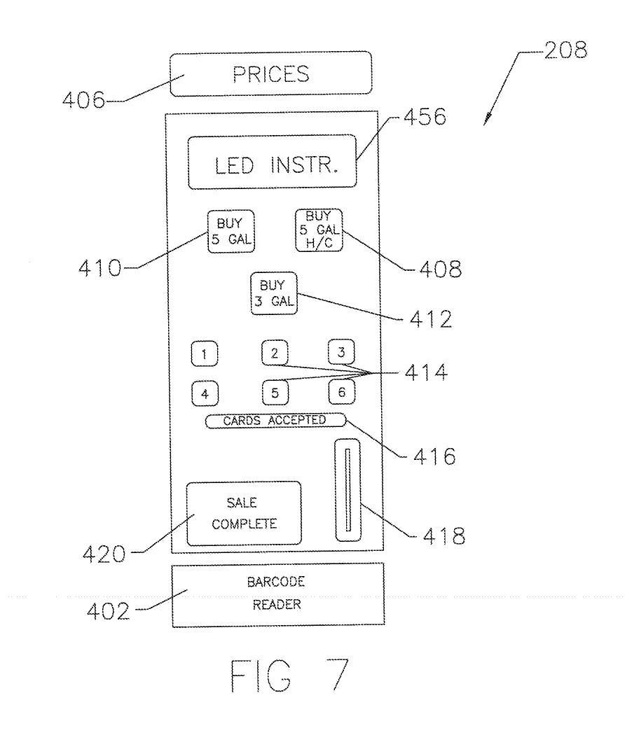

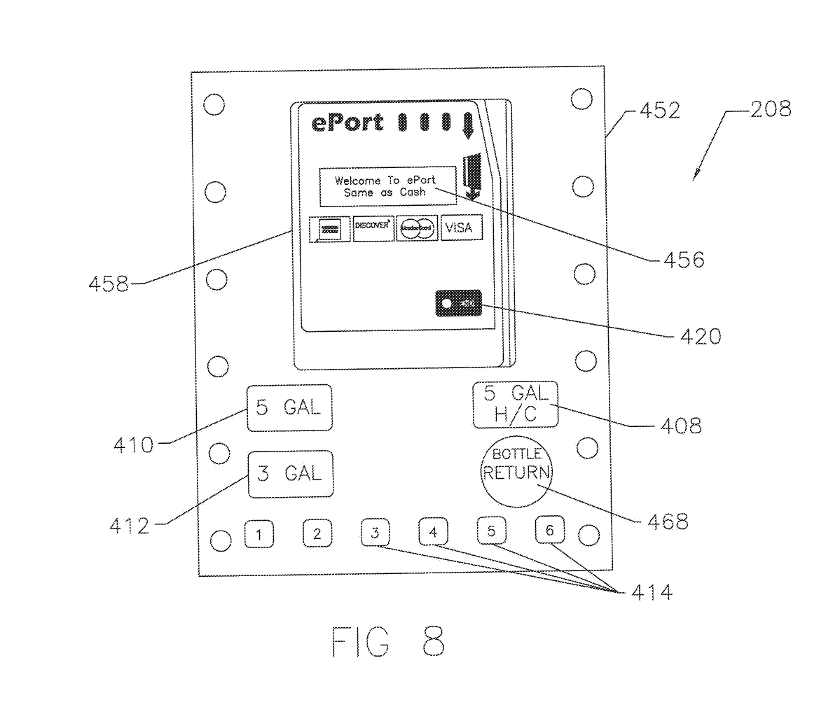

Referring to FIGS. 7 and 8, cashless customer interface keypad 208 positioned on a front wall of vending segment 202 (or alternatively, on return segment 204) provides customers with a means to perform paperless debit and credit transactions to obtain filled water bottles and to return emptied reusable bottles. To secure keypad 208 to the vending apparatus, a mounting plate 452 may be attached to, or integral with, the keypad. It should be understood keypad 208 is connected via hardwire or wireless connection to the central processor that processes information received from keypad 208 and controls operation of the vending/return apparatus.

Keypad 208 includes a credit/debit card reading slot 418 into which a card and attached magnetic strip are inserted to enable the system to read the account information embedded in the strip. An LED display window 456 provides a visual display of alpha-numeric based prompts to inform the customer of the transaction progress. Alternatively, a second display 416 may be included in the keypad to inform the customer whether the credit/debit card has been accepted. A further alternative addition is an acceptable credit/debit card list 458 to give customers advance notice of accepted accounts.

The process begins by having the customer swipe or insert a credit/debit card into the card reading slot 418. The customer then presses one of the selections for purchase. The shown options include purchase of a five gallon bottle button 410, a three gallon bottle button 412 and a handicap-access, five gallon bottle button 408. To that end, one or more conveyor rows in the apparatus are set at a height to facilitate handicap access. These conveyor rows operate in essentially the same manner as the other conveyor rows. Referring again to the button selections, to further enhance the distinction between the button choices, each can be colored coded with a different color. Of course, each button may be customized to identify any particular size bottle and more buttons may be added to reflect the bottle size choices offered. By way of example and riot limitation, a dedicated button can be included for three gallon handicap access, one gallon bottle, one gallon handicap access bottle, etc.

The customer next selects the number of bottles of the selected bottle size the customer wishes to purchase by pressing one of the numeric keys 414. The illustrative examples shown in FIGS. 7 and 8 show six numerical key options. The interface keypad may be constructed with more or less numeric key options. Once a selection number has been made, the customer is prompted on LED screen 456, or by audio prompt to open one or more specified vending doors to retrieve purchased bottles.

If return bottles are to be added to the transaction, a return bottle button 468 is depressed by the customer. The customer then exposes a barcode, or other similar marking methodology, attached to the return bottle to a barcode reader 402. Once a bottle's bar code has been successfully read, the customer is prompted visually and/or audibly to open return door 220 and insert the bottle being returned. In an alternative embodiment, return door 220 may be substituted with a return slot dimensioned to receive bottles of the sizes offered in the vending apparatus.

To ensure proper credit, the apparatus does not allow the customer to return additional bottles until the bottle previously scanned is successfully deposited in return segment 204. Each successive return bottle has to be properly and successfully scanned before being deposited in the return segment in order to receive the desired credit for the return. Additional matters involving return bottles are described more fully hereinbelow. Once the last return bottle is processed; or if no return bottles are involved in the transaction, the customer may depress an optional sale complete button 420 to enable the vending system to tabulate the debits and/or credits and finalize the transaction. An application to process sales and return transactions is disclosed more fully below.

In a yet further aspect of the disclosure, a vending elevator is provided to further increase the number of bottles storable and deliverable in a single apparatus. The apparatus includes a plurality of columns and rows to maximize bottle storage and delivery. As used herein, a column shall mean a vertical assembly of bottles supported by dedicated platforms, and a row shall mean a horizontal support for receiving and holding a plurality of bottles, or other desired objects.

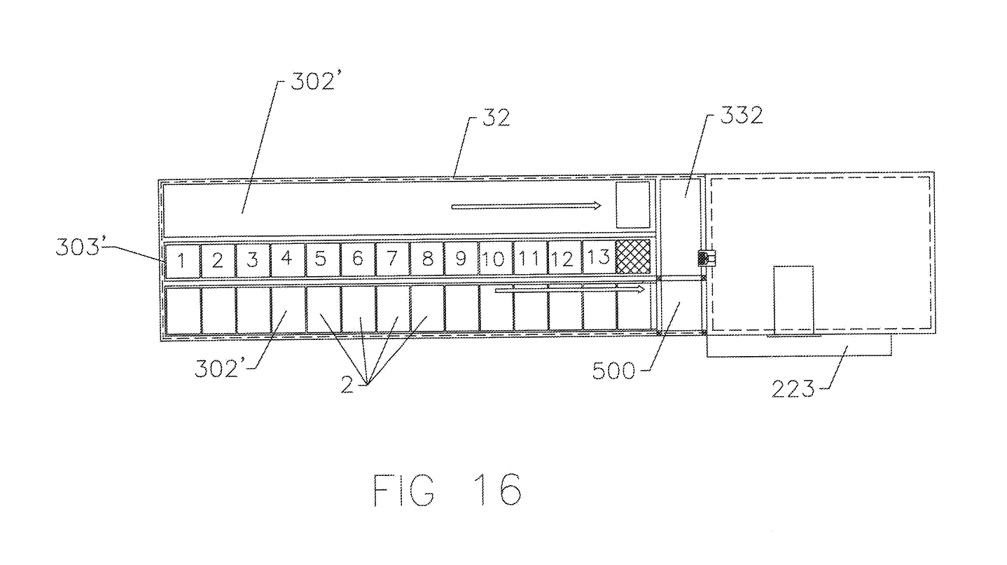

As shown in FIGS. 15 and 16, combined vending/return apparatus 10′ (elements bearing primed reference character numbers correspond to elements bearing unprimed or differently primed numbers), includes a combination of stacked gravity fed vending conveyors that merge onto substantially horizontal launch segments 380 used to initially arrest forward movement of each bottle advanced on the gravity feed conveyors 302′ (5 gallon bottle conveyors) and 303′ (3 gallon bottle conveyors). More specifically, launch segments 380 each include motor-driven conveyor belts 507 driven by dedicated processor-controlled conveyor motors 506. When activated, conveyor belts 507 urge bottles present on the conveyor belts onto a delivery elevator 500.

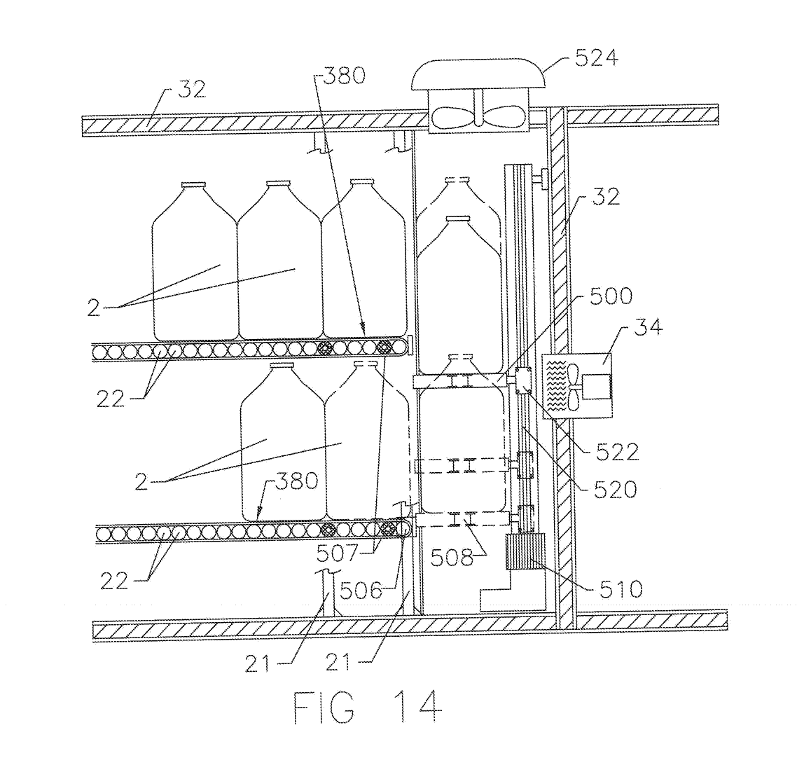

Elevator 500 is connected to one or more linear actuators to position elevator 500 to receive bottles from launch segments 380 and to position received bottles into a proper location for bottle removal by a customer. As shown in FIG. 14, a first linear actuator motor 510 is connected to a lead screw 520 that controls elevational movement of elevator 500. Elevator 500 is connected to an anchor 522 having a threaded through-bore for receiving lead screw 520. Depending on the orientation of the threads on lead screw 520, forward and reverse modes of operation of motor 510 with either raise or lower elevator 500 to desired positions within apparatus 10′.

In one aspect of the disclosure, elevator 500 is combined with outgoing conveyor 332 to bring bottles from multiple rows and columns to vending door 210. In this aspect, conveyor 332 is configured substantially as shown in FIG. 6. The coordination of launch segments 380, conveyor 332 and elevator 500 is performed by the resident computer processor disclosed herein. When a customer makes a purchase selection, the computer process determines from which row and column a bottle should be retrieved and operates launch segment 380, conveyor 332 and elevator 500 to retrieve and deliver the selected bottle.

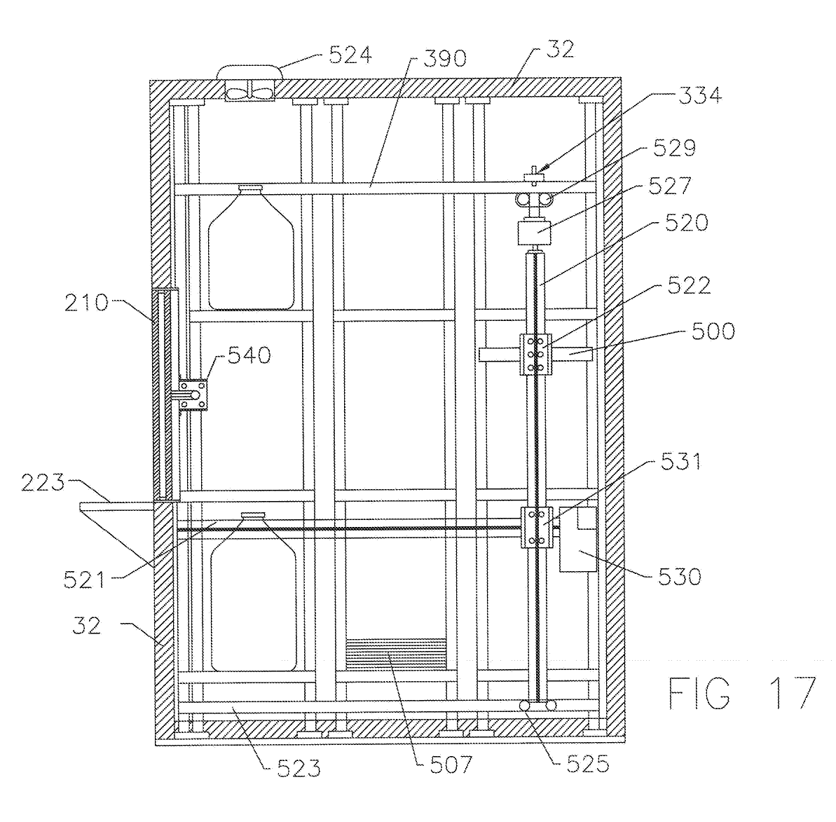

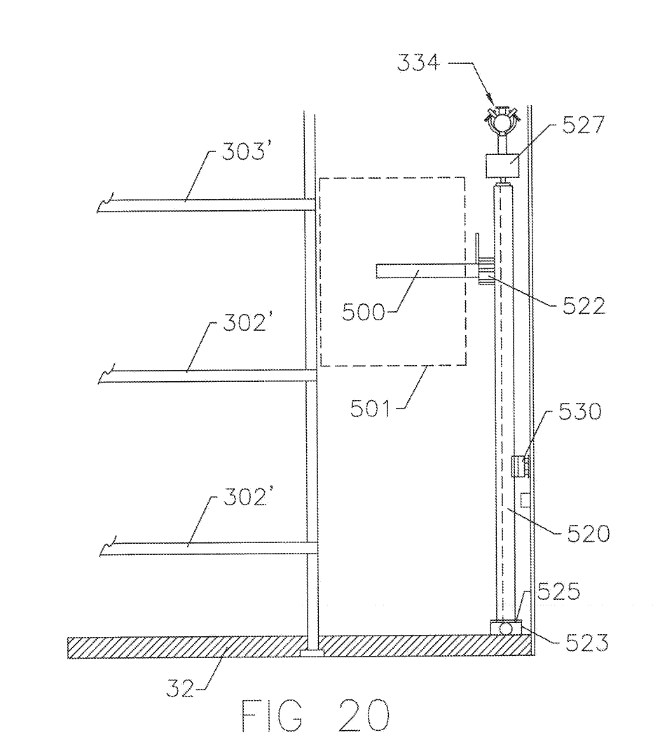

In another aspect of the disclosure, elevator 500 is not combined with outgoing conveyor 332. Instead, elevator 500 is connected to a second linear actuator to move along a second horizontal axis. As shown in FIGS. 17 and 20, elevator 500 is connected to lead screw 520, which is driven by overhead mounted motor 527 to effectuate vertical movement of elevator 500. Lead screw 520 is further connected to horizontal anchor 531 that includes a threaded bore to receive a second lead screw 521 and a through-bore and bushing for receiving lead screw 520. Lead screw 521 is operated by attached horizontal motor 530.

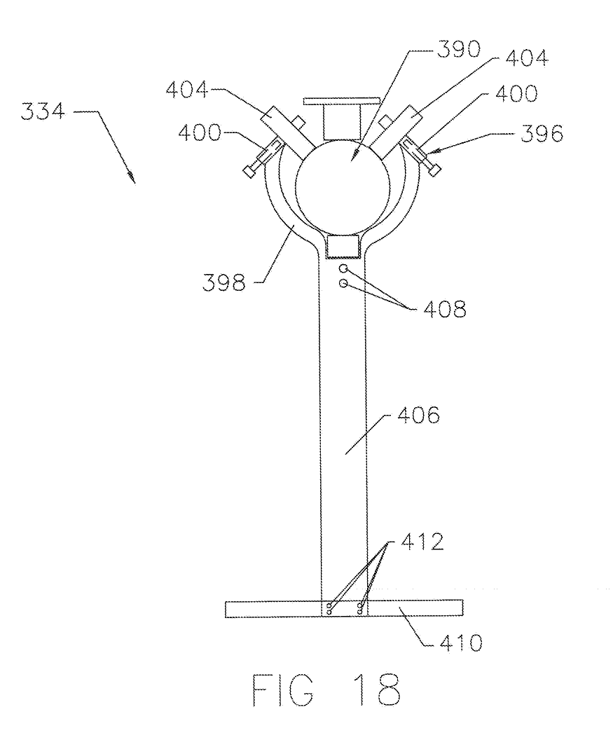

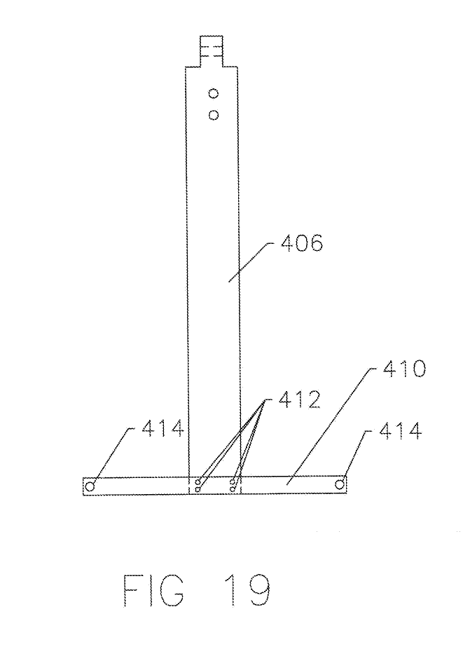

To enable horizontal movement of elevator 500, a lower track 523 having a cross-sectional shape of a flattened “u” is configured to receive actuator roller wheels 525 secured to a lower end of lead screw assembly 520. To secure an upper end of lead screw assembly 520, slide bar 390 is positioned to extend substantially along a top end of the apparatus' sidewall to guide horizontal movement of the vertical lead screw assembly. Yolk assembly 334 (shown more particularly in FIGS. 18 and 19), has motor-driven wheels 529 that propel lead screw assembly 520 along slide bar 390. Both lead screws may be operated simultaneously or serially to align elevator 500 with a specific column and row location and/or align the elevator with access door 210 at an outgoing vend position 501.

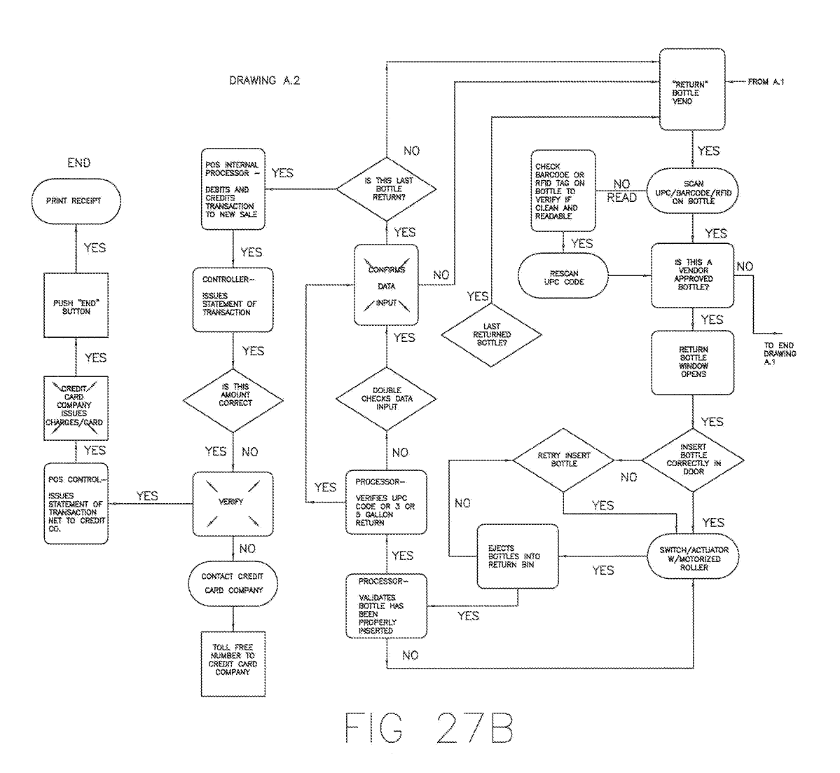

In a yet further aspect of the disclosure as shown in FIGS. 28, 29 and 30, an integrated vending/return apparatus 10″ includes a series of stacked gravity fed vending conveyors having open front ends to permit delivery of individual bottles from a single exit point, and a return bottle conveyor superposed about the vending conveyors along a perimeter of the apparatus. This configuration minimizes the amount of space necessary to perform bottle vend and return functions from a single, streamlined, simplified and integrated unit. This embodiment further substantially reduces the number of operating parts needed to perform the desired functions.

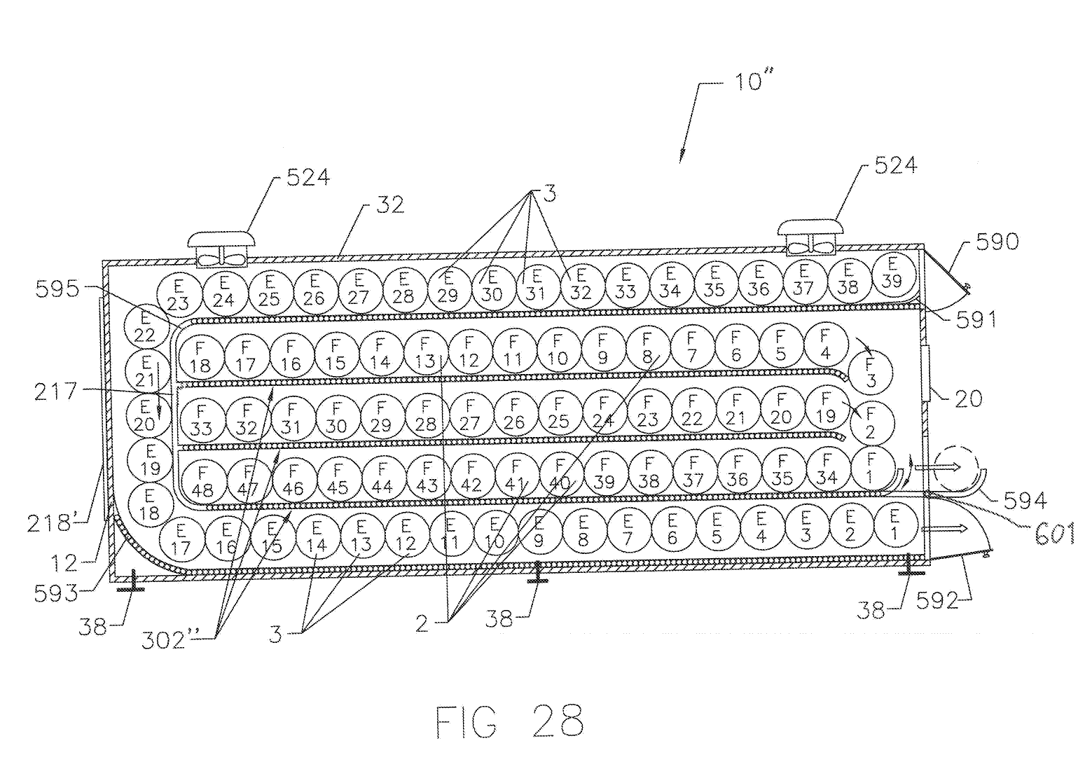

In this embodiment, apparatus 10″ includes a plurality of stacked conveyors 302″ constructed from paired rails (as shown in FIG. 5) between which are secured a plurality of rollers 304 that allow water-laden bottles to move freely toward a front end. In an alternate embodiment, Teflon® coated slick-rails may be used rather than rollers. The stacked rows can be contained within a number of columns aligned along the width of the apparatus as shown in FIG. 29. Each water bottle delivery conveyor extends from a back wall—having an access door 217 to load the conveyors—to a point short of the apparatus front wall. The distance between a front end of the conveyors to the front wall is greater than the bottle size used in the apparatus.

To access the vending conveyors from the exterior, a full swing door 218′ is secured to a back wall of apparatus 10″. Both door 218′ and door 217 have to be opened to provide access to vending conveyors 302″. To access the vending conveyors, return bottles 3 must be removed from apparatus 10″.

To return bottles, a customer exposes a bar code on the return bottle to the bar code reader 17 that sends a signal to the processor to unlock return door 590. The customer places the bottle in the upper conveyor return channel to return the bottle. A sensor positioned in close proximity to the front opening ensures the bottle is inserted into the return channel before a credit is given. Although the return channel is sloped to urge return bottles 3 towards the back of the apparatus, a front radius ramp 591 may be used to prevent return bottles from inadvertently spilling out of the front end of apparatus 10″ before door 590 is returned to a closed position.

To ease the movement of return bottles along the upper return channel and down a substantially vertical connected channel as the back of apparatus 10″, a radius 595 may be formed at the juncture of the return channel and the vertical channel. To further ease movement of the return bottles a second radius 593 may be formed at a bottom outside corner formed by the junction of the vertical channel and a bottom return channel. The bottom return channel is sloped toward the front of apparatus 10″ to urge return bottles 3 toward the front of the apparatus.

To retrieve return bottles, a front unload door 592 is secured to the front wall of apparatus 10″ to provide access to the bottom return channel. For ease of use, unload door 592 is hinged at a bottom edge to allow the door to function as a ramp and to allow gravity to keep the door open while return bottles 3 are removed. Due to the structure of the return bottle channels, the entire insertion and removal procedure may be achieved without the use of power-assisted rollers as gravity provides the necessary force to urge the bottles to the front of apparatus 10″ adjacent to unload door 592. In an alternative embodiment, a radiused ramp, similar to radius ramp 591, may be formed at the front end of the bottom return channel to prevent bottles from spilling out of apparatus 10″ when unload door 592 is opened.

To ensure the slope of each conveyor is set properly, leveling feet 38 are provided on a bottom of apparatus 10″ to ensure the apparatus' casing is level and plumb. The slopes of the conveyors are set relative to the plane occupied by the bottom or floor of apparatus 10″. The slopes may be from about 1° to about 20°.

To retrieve a full bottle, a customer has to operate credit card acceptor 20 as described herein. Once the credit transaction and number of bottles are approved, the processor operates a radius door 594. Radius door 594 is secured to a welded rod 601. One end of rod 601 is secured to a pillow bearing 602 and the other end is secured to gear motor 600. Motor 600 is operated by the processor. In one embodiment, a shelf basket 598 is secured to the front of apparatus 10″ below the lowest point of door 594 when in an open position. When a bottle is purchased, door 594 rotates open. The radius of the door, conformed to the shape of the bottle, cradles the bottle until retrieved by the customer. With the embodiment employing basket 598, a purchased bottle exits apparatus 10″ via gravity and comes to rest in basket 598. The basket shelf has openings between rails that provides further access points for a customer to remove the purchased bottle from apparatus 10″.

In a yet further embodiment, a retractable, substantially horizontal slide door 597 may be secured to a front end of the second highest vending conveyor 302″ to prevent full bottles from collapsing on bottles being vended from the primary of lowest vending row to which door 594 is aligned. Door 597 is secured to an actuator that can retract the door when the primary vending row is depleted of full bottles. The processor either receives a signal, or does not receive a signal from a sensor placed in the primary vending row to indicate an empty row status. Once this signal, or absent signal is received, the processor sends an “open” signal to the actuator to open door 597 to allow one bottle to travel onto the primary vending row for delivery to a customer. Door 597 is closed after a single bottle is released to ensure additional bottles do not collapse on the bottle to be delivered to the next customer.

As with the other disclosed embodiments, this embodiment includes solar-powered vents 524 that operate continuously to adjust pressure and temperature with the heating and/or cooling units. A series of lights 596, e.g., fluorescent, may be secured to an eaves of the apparatus' top to provide adequate lighting and added security during nighttime purchases. Consistent with the other embodiments, this embodiment also includes credit card acceptor 20 positioned on the front wall of apparatus 10″. Credit card acceptor 20 may also be positioned on a sidewall depending upon the orientation of apparatus 10″ relative to surrounding structures, e.g., a grocery store.

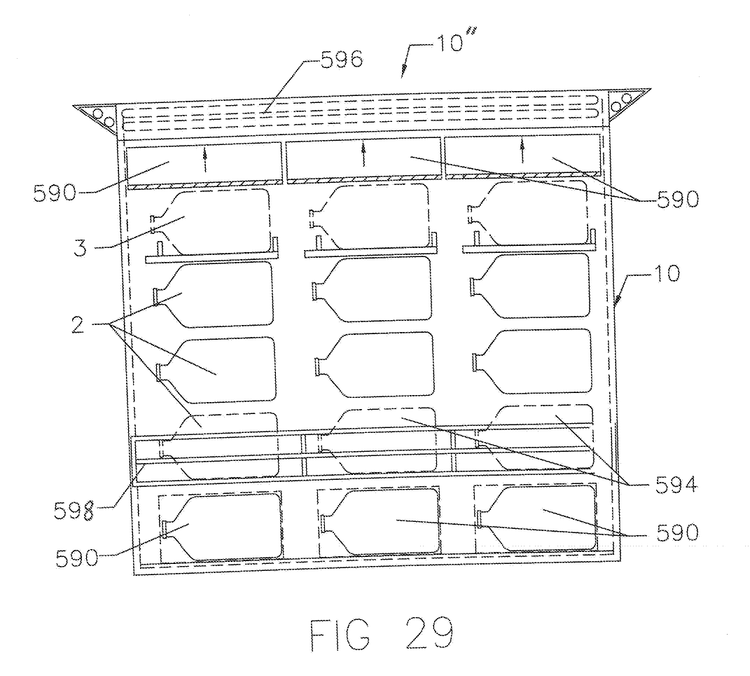

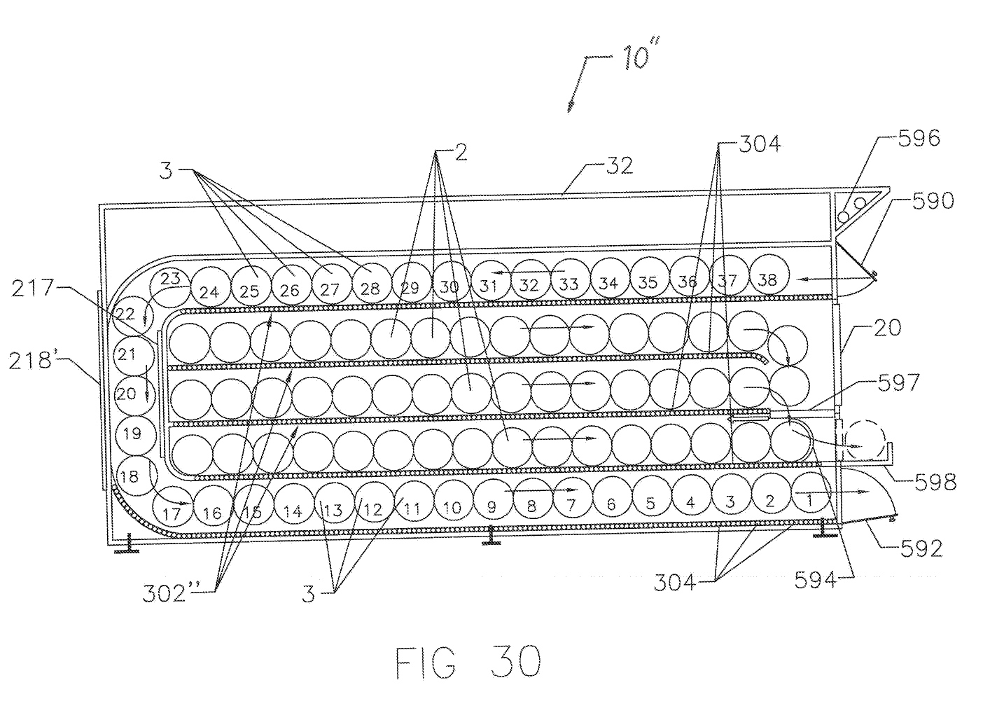

In a yet further aspect of the disclosure, integrated vending/return apparatus 10″ may be modified as shown in FIG. 31 to include shortened vending rows to allow front loading of full bottles. In one embodiment, two conveyor rows designated as return rows are positioned at the top of a column of rows. The rows are either level or graded to urge bottles to travel to the back of the apparatus. In this embodiment, return bottles 3 are removed from an access door at the back of the apparatus. Each row has a dedicated return door 590 which operates in similar fashion to the return door shown in FIG. 30. As should be appreciated, the number of return conveyor rows may range from 1 to 2 or 3. The primary limitation to the number of rows is the height of the highest return door that should be within reach by a person of average height.

Positioned below the return conveyors are conveyors 302″ designated as vend rows. One or more vend rows may be included in a column of conveyors. The vend rows are graded to urge bottles 2 toward the front of the apparatus, which also serves as the loading point for bottles 2. The slopes may be from about 1° to about 20°. Each vend conveyor row runs from a back end of the apparatus to a point separated from the front end of the apparatus. Each conveyor row has a rotatable restriction cradle 591a that may be configured with a radiused cross-section to conform to the shape of bottles 2. Cradles 591a are hinged to the front end of the conveyor rows and are rotated by a motor in similar fashion to door 594 shown in FIG. 28. The distance between the open end of the cradle in a “down” position and the front end of the apparatus is greater than the cross-sectional dimension (diameter for round/cylindrical bottles) of bottle 2. Each cradle is maintained in an “up” position to restrict bottle movement until a purchase has been made.

One a purchase has been made, the processor sends a signal to the cradle motor to rotate cradle 591a from the “up” position to the “down” position so as to allow the passage of the front-most bottle 2 to travel onto door 594. Once loaded onto door 594, the processor sends a signal to the cradle motor to rotate the cradle back to the up/bottle restriction position. Once cradle 591a is in the up position, a signal is sent to the processor to confirm the up position. The processor next sends a signal to the door motor to rotate door 594 to the down/delivery position so as to present the bottle for retrieval by the customer. This may include delivery of the bottle to rack 598. Once the bottle is removed and a signal is sent back to the processor to indicate bottle removal, the processor sends another signal to the door motor to rotate door 594 back to the closed position. To load the apparatus, the system is configured to allow the vendor to open the vend door without a purchase transaction.

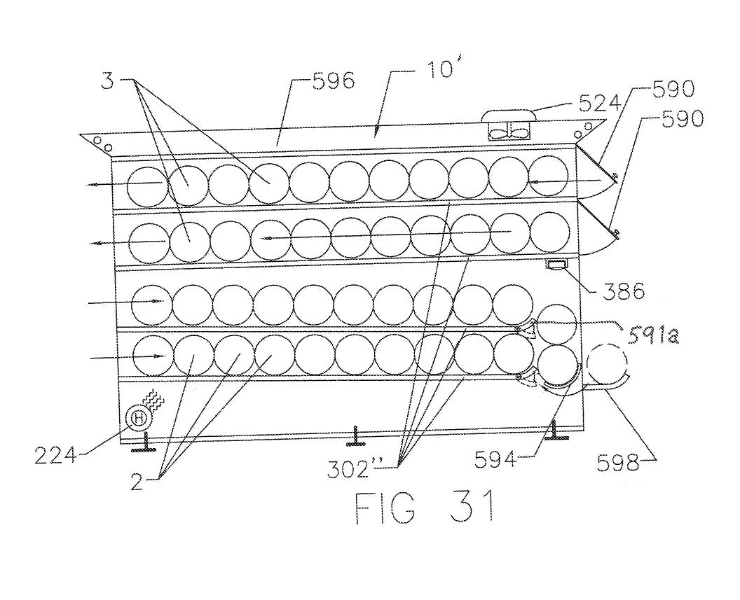

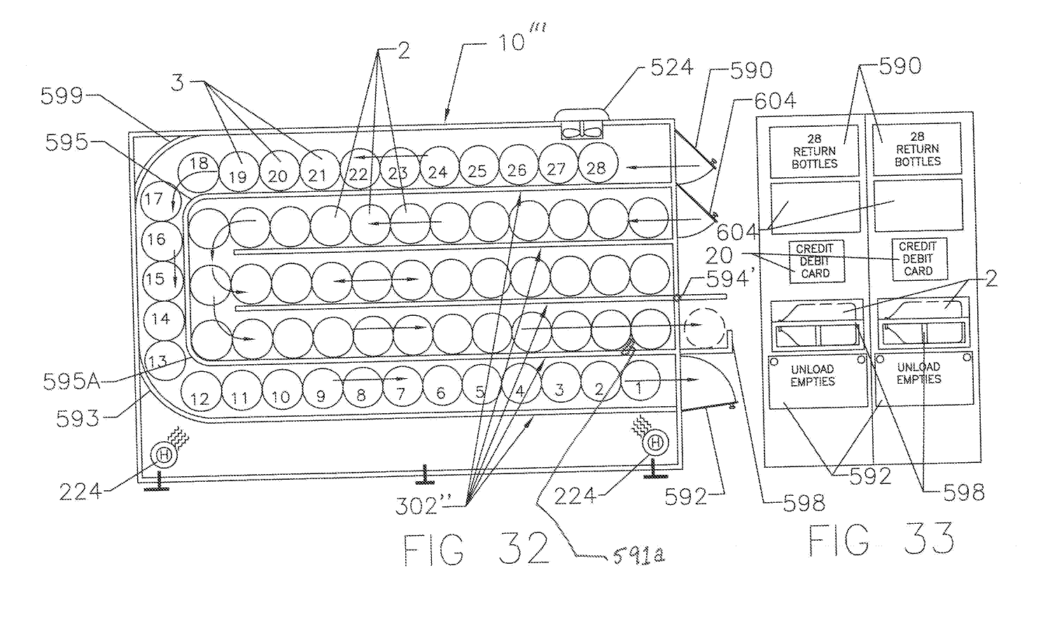

In a yet further aspect of the disclosure, as shown in FIGS. 32 and 33, vending apparatus 10′″ includes a plurality of conveyors to receive and vend bottles. The rows may be sloped purposefully to allow gravity to urge bottles in a desired direction. The slopes may be from about 1° to about 20°. As with other gravity feed embodiments, sloped conveyors may be substituted with substantially level conveyors having power rollers as described herein, or a combination of both.

As shown in FIGS. 32 and 33, apparatus 10′″ includes a series of stacked conveyors 302″. An uppermost conveyor is dedicated to receive return bottles using door 596 as an access way. As with the prior embodiment, the uppermost conveyor includes a radiused transition 595 to a substantially vertical wall that in part defines a substantially vertical return bottle channel connected to a lowermost conveyor that leads to access door 592. As with a prior embodiment, door 592 allows return bottles 3 to be retrieved by the vendor.

To ensure the return bottles travel in the correct direction, the uppermost conveyor is configured with a downward slope going from a front end to a back end of apparatus 10′″. The lowermost conveyor is configured with a downward slope going from a back end to a front end of apparatus 10′″. To prevent return bottles 3 from becoming impinged at any of the conveyor transition points, radiuses 595a, 593 and 599 may be formed at the junctions. It should be noted that in this embodiment, the back wall of apparatus 10′″ as well as the back wall of the vending conveyor segment do not include doors. The vending conveyors are completely isolated from the return conveyors.

With respect to the vending conveyors, two or more conveyor rows are stacked as shown in FIG. 32. A topmost vending conveyor extends from a front wall of apparatus 10′″ to a point distal to a back wall of the vending conveyor segment. The distance between the end of the uppermost conveyor and back wall is dimensioned to allow filled bottles to migrate freely from the uppermost conveyor to one or more lower rows of vending conveyors. The uppermost vending conveyor is configured with a downward slope going from a front end to a back end of apparatus 10′″. This ensures filled bottles travel to the end of the uppermost vending conveyor and down onto the stacked vending conveyors.

With the exception of the uppermost vending conveyor and the lowermost vending conveyor, each intermediate vending conveyor in this embodiment extends from a point distal to the front wall of apparatus 10′″ to a point dimensionally similar to the end point of the uppermost vending conveyor. The distance between the front end of the intermediate vending conveyor and the front wall is sufficient to allow filled bottles to travel freely from the intermediate row to the lowermost vending conveyor row. This ensures the free flow of filled bottles along the entire length of the vending conveyors.

With the exception of the uppermost vending conveyor, each vending conveyor, including the lowermost conveyor, is configured with a downward slope going from a back end to a front end of apparatus 10′″. This ensures bottles 2 move toward the front of apparatus 10′″ via gravity and/or power roller feed.

The lowermost vending conveyor extends from a front end of apparatus 10′″ to the vending conveyor segment back wall. Radius 595a ensures bottles 2 travelling from the uppermost conveyor will flow freely and smoothly onto the lowermost vending conveyor and toward vend door 594. Like the prior embodiment, apparatus 10′″ may include a basket 598 to present purchased bottles 2 for retrieval by a customer.

The methods used to return empty bottles 3 and to purchase filled bottles 2 via acceptor 20 is the same as any of the other embodiments disclosed herein. As with the other embodiments, vending doors 594 and return doors 590 are electromechanically locked and unlocked to disallow and allow access, respectively. In this embodiment, however, vend door 594′ rotates to open from the top rather than the bottom of the bottom-most conveyor row.

To load this embodiment with filled bottles 2, a vendor unlocks and opens fill door 604. In this embodiment; each column in apparatus 10′″ has a dedicated fill door 604. Bottles are inserted through the door and allowed to travel down the uppermost vending conveyor and to travel down to the lowermost vending conveyor. Once the lowermost vending conveyor is full, the next successive bottle will contact the last bottle in the lower most vending conveyor row and migrate onto the lowest intermediate vending conveyor row until that row is filled as well. The process is continued until each successive intermediate vending conveyor row is filled followed by the uppermost vending conveyor row.

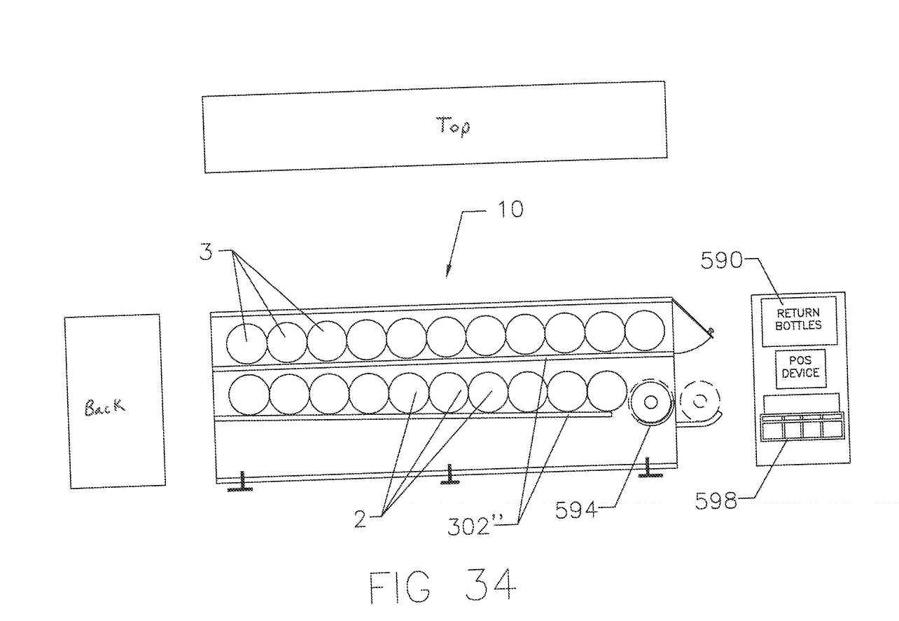

When a purchase is made, the bottle closest to door 594 travels off the front end of the lowermost vending conveyor for retrieval by the purchaser. The filled bottle immediately behind or above the vended bottle will move into the first position adjacent the now closed door 594, ready for the next purchase. A rotating stop rotates into an upward position to arrest movement of the bottle adjacent to the bottle being vended similar to cradle 591a shown in the prior embodiment. The rotation of the stop is coordinated with the rotation of door 594 to an open position by the processor. When rotating to a closed position, the stop rotates to a down position to allow the next bottle to migrate to the first position via gravity. The cradle returns to the up/restriction position once the lead-most bottle passes the cradle into the vend position. A similar stop may be positioned at a front end of the row above the vending row to arrest downward migration of bottles from the upper row into the vending position. A smaller version of apparatus 10′″ is shown in FIG. 34 in which only one return row and one vend row are incorporated into the apparatus.

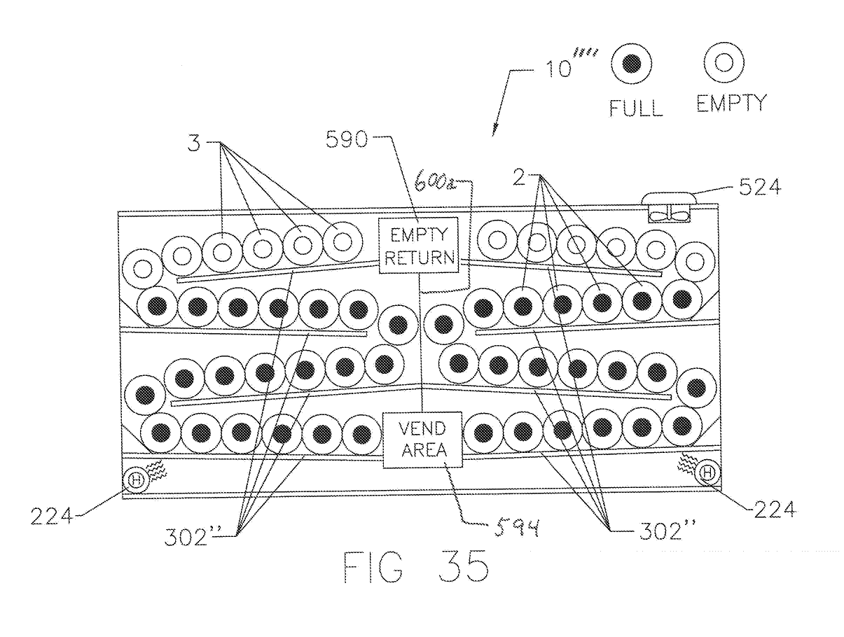

In a still further aspect of the disclosure as shown in FIG. 35, a combined vending/return apparatus 10″″ is shown in which filled bottles 2 and return bottles 3 occupy the same conveyors. The conveyors 302″ are constructed in the same manner as previously disclosed. In this embodiment, a central wall 600a extends from the apex of top-most row segments and the low point of converging bottom-most row segments. The top-most row segments are graded to slope downwardly from a point behind return door 590 toward the side walls of apparatus 10″″. The slopes may be from about 1° to about 20°. Each top-most row segment extends from a point behind door 590 to a point separated from a respective side wall. The space defined by the side wall and the segment end is dimensioned to be greater than the cross-sectional dimension of the bottles used in the apparatus. This allows bottles to travel from the top-most conveyor row to the next highest row.

The next highest row has segments that extend from a respective sidewall and slope downwardly toward center wall 600a to a point separated from center wall 600a. The space defined by the center wall and the segment is dimensioned to be greater than the cross-sectional dimension of the bottled used in the apparatus that performs the additional function of a fill door for bottles 2. The pattern of alternatingly sloped conveyor rows is repeated until reaching a final lower-most row that slopes inwardly toward vend door 594.

The segments of the lower-most row extend from a respective sidewall and slope downwardly toward center wall 600a and meet at a point at the bottom of vend door 594. This configuration ensures any bottle, filled or return, placed in the apparatus will be accessible from the vend door.

In this embodiment, return door 590 and vend door 594 perform dual functions. Return door 590 provides a means to place both filled and return bottles into the apparatus. Vend door 594 provides a means to remove filled bottles by customers and return bottles by the vendor. The doors are operated in the same manner as disclosed for the other embodiments disclosed herein including the processing of a sales transaction with acceptor 20 (not shown in FIG. 35). Bottles inserted into the apparatus will travel to either side with or without user assistance as long as there is space on a side to receive the bottle. Bottles removed from the apparatus will flow from either side and fill the space behind the vend door when available.

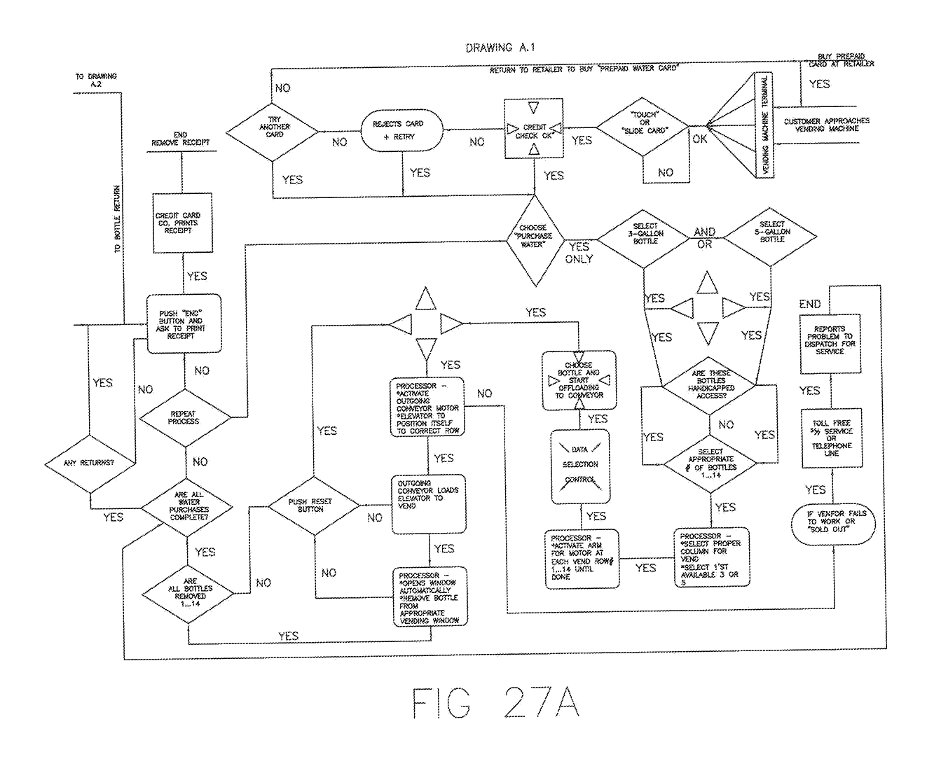

In another aspect of the disclosure as shown in FIGS. 27a and 27b, a bottle vending application is shown generally as 100. The application begins with the customer approaching and operating the vending machine terminal 104. Terminal 104 is configured to receive credit/debit cards and/or prepaid purchase cards 102 purchased from the retailer adjacent the vending apparatus. Depending upon the configuration, the customer touches or slides the card in the reader at step 106. If the attempt to engage the reader is unsuccessful, the customer is prompted to try again after a predetermined time period to read the card information lapses. The system may be configured to allow for a predetermined number of tries to have the card read before the system declines to read the card.

If the card is read successfully with the first attempt, or any successive attempt, the system performs a credit check by logging onto the credit card company's website at step 108. If the credit check returns a negative result, the system rejects the card at step 110 and informs the customer with a visual and/or audible prompt to retry entering the card. The system may be configured to allow a predetermined number of tries to retry the card and receive a positive credit check result.

If the customer retries the same card up to the predetermined allotted tries and receives the same negative result, the system prompts the customer to try another card at step 112. The customer can either go or return to the retailer to purchase a prepaid card, or have a defective prepaid card replaced, and try the new or replaced prepaid card. Alternatively, the customer can use a different credit/debit card and engage the card reader at step 106. The presence of a new card resets the predetermined number of tries to either read and/or verify positive credit at steps 106 and 108 respectively.

Once a credit check result is positive, the customer is prompted to purchase water at step 114. To ensure the vendor does not give out credits for third party bottles or for bottles retrieved from prior customers without subsequent purchases, the choice is limited initially to a purchase transaction. The system allows customers the option to obtain credit after the purchase portion of the transaction has been completed as disclosed below. Thus, the first purchase by any customer results in the cost of the bottle being borne by the customer. The customer can also re-sell an empty bottle back to the creditor by purchasing additional units and returning emptied bottles. Thus, a customer may choose to buy only one bottle and leave without a return, or upon a subsequent purchase return the empty from a previous purchase.

In one embodiment, the customer is given the option to select 3-gallon bottles at step 116, 5-gallon bottles at step 118, or a combination of the two by selecting the combo option at step 120. With respect to a vending apparatus incorporating an elevator delivery shelf, the bottles are delivered at approximately a 30 inch height to ensure handicap access. In another embodiment, wherein there are multiple vending doors at different heights, the customer is prompted to select whether the bottles to be delivered require handicap access at step 122. If yes, the vending apparatus discharges purchased bottles from a lower door rather than a higher door. The customer next selects the number of bottles to be purchased in the transaction at step 124.

Once the number (1 . . . n) and size of bottles have been selected, the system processor selects the column from which the bottles will be distributed at step 126 so as to select the first available bottle in a specified row, which represents the oldest bottle present in the vending apparatus. The system processor next selects the row from which the purchased bottles will be delivered at step 128 and activates the motor associated with the particular row until the correct number of bottles purchased has been fed into the vending segment of the vending apparatus. The system then enacts a data selection control to ensure proper alignment of purchase request and vended bottles.

Once a bottle is selected for vending at step 132, the vending apparatus starts the offloading to conveyor process. The processor then selects the row at step 134 and activates the outgoing conveyor motor and operates the elevator to position it to the correct row at step 136. Once the elevator is in the correct position, the outgoing conveyor loads the elevator to vend the bottle at step 144. If the elevator is not loaded, the processor prompts the customer to push a reset button at step 146. The processor then returns to the select row step 134, and again activates the conveyor motor and operates the elevator if not in the correct position relative to the selected row. If either the conveyor motor fails to operate, or the elevator is not positioned correctly relative to the selected row for a second cycle, i.e., a vend failure, or the bottles are in a sold out condition determined at step 138, the processor prompts the customer to call a toll free number for a 24/7 service line at step 140. The customer then reports the problem to a dispatcher for service at step 142.

If the outgoing conveyor successfully loads the elevator to vend at step 144, the processor operates an automated window to open it at step 148. The customer can now remove the selected bottle from the vending apparatus. If the door fails to open, the processor returns to the reset step 146, which either attempts the cycle for a second time, or directs the customer to call the dispatcher if the failure is a second cumulative failure. The row selection, conveyor operation, elevator operation, and door operation cycle is repeated for as many bottles as are purchased.

The system then determines if all purchased bottles have been removed successfully from the appropriate vending window at step 150. If not, the system returns, repeatedly if necessary, to step 148. The system next prompts the customer to confirm whether the water purchase is complete at step 152. If the customer decides to purchase additional bottles at step 154, the system returns to step 114 to allow the customer to select additional bottles. If the customer decides not to purchase additional bottles, the system asks the customer whether the customer wishes to return any empty bottles at step 153. If no, the customer is prompted to push an “End” button and request a printed receipt at step 156. The credit card company processes the transaction and sends instructions back to the system that prompt the system to print a receipt at step 158. The receipt is removed and the transaction completed at step 160.

If the customer selects returns at step 153, the system goes to the return bottle cycle at step 162. The customer is prompted to scan a UPC and/or barcode, RFID marking/label at step 164. If the system fails to read the code, the customer is prompted to check the barcode label to determine if it is clean and readable at step 166. The customer is then prompted to try to rescan the code at step 168.

If the scan is successful at either step 164, or upon retry at step 168, the system determines if the return bottle is a “vendor approved” bottle at step 170. If not, the customer is asked whether this is the last return bottle at step 171. If yes, the system goes to 156 and prompts the customer to push the “End” button to begin the final transaction sequence. If not the last return bottle, the system returns the customer to step 162 to begin the next return bottle cycle.

If the bottle is determined to be a vendor approved bottle at step 170, the return bottle window opens at step 172. The customer then inserts the bottle in the correct geometric orientation to match the geometric configuration of the return bottle window opening at step 174. If the bottle is successfully inserted, a switch/activator with motorized roller is activated at step 180 to eject the bottle into the return bin at step 178.

If the bottle is not properly inserted into the return bottle window, the customer is prompted to retry at step 176. If successful, the switch/activator is activated at step 180. If not, the customer is directed to call the toll free 24/7 service number at step 138. If the problem is not resolved, the customer is next asked if there are any other return bottles at step 177. If yes, the system returns to step 162. If no, the system goes to step 156 to complete the transaction.

If the bottle is successfully deposited into the return bin, the processor validates that the bottle has been properly inserted at step 182. If no, the system returns to step 180 to begin the insertion process again. If yes, the system verifies the “serialized” UPC and/or RFID code of the 3 or 5 gallon bottle return at step 184. If verification is not successful, the system rechecks the code at step 186. If the code isn't verified, the system cancels the original UPC code scan and sends the customer back to step 162 to start the return process again. If the code is confirmed at step 188, the system queries the customer whether the processed return bottle is the last bottle at step 190. If no, the system returns the customer to step 162 to begin processing the next return bottle. If yes, the system combines the debit and credit transactions to arrive at a net sale at step 192.

If the customer uses a pre-paid card to pay for water and has returns, the customer may simply return the bottle as usual and the “prepaid water card” will be reimbursed for the transaction as if the customer had “paid additional funds”—similar to a prepaid “transit card” whereby the card can be “recharged by putting it back into a transit card machine and paying additional money. The system controller issues a net statement of transaction at step 194. The customer is now queried as to the correctness of the amount at step 196. The system receives the customer's verification input at step 198. If the amount is disputed, the system prompts the customer to contact the credit card company at step 200. The customer is given a toll-free number to the credit card company at step 202.

If the amount is correct, the system issues a statement of the net transaction to the credit card company at step 204. The charges are processed by the credit card company and transmitted to the vendor's account at step 206. Once the system receives verification that the transaction has been completed with the credit card company, the customer is prompted to push an “END” button at step 208 to end the transaction. The system prints a receipt and the transaction is completed at step 210.

While the present disclosure has been described in connection with one or more embodiments thereof, it will be apparent to those skilled in the art that many changes and modifications may be made without departing from the true spirit and scope of the disclosure. Accordingly, it is intended by the appended claims to cover all such changes and modifications as come within the true spirit and scope of the disclosure.

Having thus described my disclosure, what I claim as hew and desire to secure by United States Letters Patent is:

1. A combination bottle vending/return apparatus comprising:
an enclosure comprising a front wall, a back wall, and side walls that connect the front wall to the back wall;
at least one bottle vending conveyor secured in the enclosure and configured to support and deliver fluid-filled bottles;
at least one bottle return conveyor secured in the enclosure and superposed about the at least one bottle vending conveyor, wherein the return conveyor is configured to support and hold return bottles;
a customer interface panel configured to permit customer-initiated bottle vend and/or return transactions; and,
a processor connected to the interface panel to send and receive signals to and from the interface panel and connected to a credit/debit/pre-paid card processor.

2. The apparatus of claim 1 wherein the at least one vending conveyor is oriented in the enclosure to slope downwardly from a back to a front of the enclosure, and wherein a back end of the vending conveyor extends to a plane separated from the back wall, wherein the distance from the vending conveyor back end and the back wall is greater than the cross-sectional dimension of a fluid-filled bottle configured for use in the apparatus.

3. The apparatus of claim 2 wherein the slope is from about 1° to about 20°.

4. The apparatus of claim 2 wherein the at least one return conveyor comprises a top return conveyor portion positioned above the at least one vending conveyor, a back return conveyor portion connected to an end of the top return conveyor portion and positioned between the back wall and a back end of the vending conveyor, and a bottom return conveyor portion connected to a second end of the back conveyor portion and positioned between a bottom of the enclosure and the vending conveyor.

5. The apparatus of claim 4 wherein the top return conveyor portion is sloped downwardly from a front end to a back end of the enclosure, wherein the back return conveyor portion extends substantially vertically along the back wall, and wherein the bottom return conveyor portion slopes downwardly from the back end of the enclosure to the front end.

6. The apparatus of claim 5 wherein the slopes of the top return conveyor portion and the bottom return conveyor portion are from about 1° to about 20°.

7. The apparatus of claim 6 wherein the at least one vending conveyor further comprises a pivoting cradle secured to a front end of the vending conveyor.

8. The apparatus of claim 2 wherein the at least one vending conveyor further comprises a pivoting cradle secured to a front end of the vending conveyor.

9. The apparatus of claim 8 further comprising a vend door secured to the front wall so as to align with the at least one vending conveyor and wherein the door is controlled by the processor.

10. The apparatus of claim 9 further comprising a return door secured to the front wall so as to align with a front end of the top return conveyor portion and wherein the return door is controlled by the processor.

11. The apparatus of claim 10 further comprising a sensor secured in the enclosure in proximity to the return conveyor, wherein the sensor is configured to detect the presence of a return bottle, and wherein the sensor is connected to the processor wherein the sensor sends signals to, and receives signals from, the processor.

12. The apparatus of claim 1 further comprising a temperature-controlled heating unit secured in the enclosure to heat the enclosure.

13. The apparatus of claim 1 further comprising a temperature-controlled cooling unit secured in the enclosure to cool the enclosure.

14. The apparatus of claim 9 further comprising a second sensor secured in the enclosure in proximity to the vend door, wherein the second sensor is configured to detect the presence of a filled bottle positioned to removal from the apparatus, wherein the sensor sends signals to, and receives signals from, the processor.

15. A combination bottle vending/return apparatus comprising:
an enclosure comprising a front wall, a back wall, and side walls that connect the front wall to the back wall;
a secondary back wall spaced away from the back wall;
at least one column of a plurality of bottle vending conveyors secured in the enclosure and configured to support and deliver fluid-filled bottles, wherein one of the plurality of vending conveyors is a top vending conveyor positioned above the other vending conveyor(s), and wherein the top vending conveyor extends from the front wall to a plane separated from the secondary back wall, wherein the space defined between the secondary back wall and a back end of the top vending conveyor is larger than the cross-sectional diameter of a bottle configured for use in the apparatus;
at least one bottle return conveyor secured in the enclosure and superposed about the plurality of vending conveyors, wherein the return conveyor is configured to support and hold return bottles;
a customer interface panel configured to permit customer-initiated bottle vend and/or return transactions; and,
a processor connected to the interface panel to send and receive signals to and from the interface panel.

16. The apparatus of claim 15 wherein the top vending conveyor is sloped downwardly from a front end to a back end.

17. The apparatus of claim 16 wherein the plurality of vending conveyors comprises a bottom vending conveyor positioned below the top vending conveyor, wherein the bottom vending conveyor is secured to, and extends from, the secondary back wall to the front wall.

18. The apparatus of claim 17 wherein the bottom vending conveyor is configured to slope downwardly from the secondary back wall to the front wall.

19. The apparatus of claim 18 wherein the slopes of the top vending conveyor and the bottom vending conveyor are from about 1° to about 20°.

20. The apparatus of claim 19 wherein the plurality of vending conveyors comprises at least middle vending conveyor positioned between the top vending conveyor and the bottom vending conveyor wherein the at least one middle vending conveyor extends from a plane separated from the front wall of the apparatus to a plane distal to the back wall, wherein the space defined between the at least one vending conveyor and the front wall is greater than the cross-sectional dimension of a water bottle configured for use in the apparatus, and wherein the space defined between the at least one middle vending conveyor and the secondary back wall is greater than the cross-sectional dimension of a water bottle configured for use in the apparatus.

21. The apparatus of claim 20 wherein at least one middle vending conveyor has a retractable horizontal door that occludes the space between the front edge of the conveyor assembly and the front wall of the apparatus.
